(19) United States
(12) Patent Application Publication
(10) Pub. No.: US 2007/0244769 A1
(43) Pub. Date: Oct. 18, 2007

(54) USER INTERACTION FOR TRADING SYSTEM AND METHOD

(75) Inventor: Greg Boesel, Charlestown, MA (US)

Correspondence Address: MILLS & ONELLO LLP, ELEVEN BEACON STREET, SUITE 605, BOSTON, MA, 02108, US

(73) Assignee: SWAPTREE, INC., Boston, MA (US)

(21) Appl. No.: 11/733,835

(22) Filed: Apr. 11, 2007

Related U.S. Application Data
(63) Continuation-in-part of application No. 11/279,782, filed on Apr. 14, 2006.
(60) Provisional application No. 60/744,944, filed on Apr. 17, 2006.
(60) Provisional application No. 60/747,597, filed on May 18, 2006.

(51) Int. Cl. G06Q 30/00

(52) U.S. Cl. 705/26

(57) ABSTRACT

User interactive systems and methods are provided for using an automated trading system that can comprise a storage system for storing a set of data representing users and an associated tradable items, a trade module for determining at least one trade among at least two users using the data representing the tradable items, and an interface for transmitting a signal representing at least a portion of the trade.

### CROSS REFERENCE TO RELATED APPLICATIONS

This application claims the benefit under 35 U.S.C. §119(e) of U.S. Provisional Application No. 60/744,944, filed Apr. 17, 2006, entitled USER INTERACTION FOR TRADING SYSTEM AND METHOD, and also of U.S. Provisional Application No. 60/747,597, filed May 18, 2006, entitled MARKETING SYSTEMS AND METHODS IN AUTOMATED TRADING CONTEXT. And this application is a continuation-in-part application of U.S. patent application Ser. No. 11/279,782 filed Apr. 14, 2006, entitled AUTOMATED TRADING SYSTEM AND METHOD.

### TECHNICAL FIELD

This disclosure relates generally to trading systems and methods and, more particularly, to user interaction with such trading systems and methods.

### BACKGROUND

Many people readily acquire goods from multiple sources, such as, for example, large discount stores, malls, mail order catalogs, television shopping channels and internet sites. An increasing number of these sources can also utilize postal or other delivery services to deliver goods to customers. The increased availability of delivery-based shopping sources has generally increased consumers access to a wide variety of goods.

While consumers may have experienced increased access to a variety of goods, there remains relatively limited options to dispose of unwanted goods. Over time people can accumulate goods that for various reasons they no longer want to possess. For example, a person might no longer need the use of a good, might no longer desire to keep a good, or could receive an unnecessary or redundant good as a gift. If a person no longer wants a good they must decide how to dispose of the unwanted good.

One method of disposing of an unwanted good can be to sell the good. A person can sell a good at a market for second-hand or used goods. Recently, some internet sites have allowed people to sell and buy used goods. Some internet sites allow the general public to view goods offered for sale and bid on the goods via an auction system. Such sites can benefit from large numbers of people viewing the goods offered for sale and potentially bidding on the goods.

Another method of disposing of unwanted goods can include trading the goods. In some instances a person can offer to trade a good to another person for a different good. Generally such trading requires that the people involved in the trade must come to an agreement regarding the respective values of the goods to be traded. Further, for a trade to occur between two people both should want a good offered for trade by the other person. Such trading between two people can be limiting as both people must receive goods the other person possesses and wants to trade.

Some internet sites have been developed to permit internet-based trades. Generally these sites have used a limited variety of different trading methods. For example, some sites used token, or other quasi-currency systems, to assign an arbitrary “value” to goods. Such systems generally allowed a person to set the value of their goods using a quasi-currency system offered by a site. A person can then participate in trades with other people using the quasi-currency system and trade for other goods based on the respective value of the goods. Trades for goods of different value often result in credits or debits to accounts held by the people participating in the trade.

Other internet sites provided trading systems utilizing negotiated trades. Such systems typically permit people to provide descriptions of their goods for trade. If Person B wished to trade for a good of Person A, Person B can read the description of Person A's good and then propose a trade based on the description of the good. Person A can then view Person B's list of goods for trade to determine if a suitable trade could be made. Additional negotiations between the two people can be required to complete the trade, such as, for example, including additional items or money in the trade to even up the value of the goods, requesting additional information about the goods, determining who pays for shipping the goods, insurance costs, etc.

These and other internet-based trading operations generally did not provide efficient or effective methods to trade unwanted goods. Some sites were complicated or difficult to use, often requiring people to value their goods or provide descriptions of their goods. Other sites often required people to spend long periods of time determining possible trades, selecting goods, negotiating trades or updating information.

The present disclosure is directed to overcoming one or more of the problems described above.

### SUMMARY OF THE DISCLOSURE

In accordance with one aspect of the present disclosure, provided is a method of generating a set of user interface mechanisms for presentation via a user device to facilitate automated trading of items among two or more users. The method comprises generating input mechanisms configured to receive an item identification for a first tradable item from a first user associated with an automated trading system. And the method includes, in response to receiving the item identification, generating an output indicating at least one other tradable item associated with a trade involving the first tradable item, wherein the at least one other tradable item is associated with at least one other user associated with the automated trading system.

The trade can be an N-way trade that includes more than two tradable items and more than two users associated with the more than two tradable items.

The first tradable item can be a have item of the first user and the input mechanisms can include mechanisms configured to enable the first user to initiate a trade for a second item from the at least one other tradable item.

The input mechanisms can include mechanisms configured to enable the first user to add the second item to a want list of the first user.

The method can further include, upon initiation of a trade for the second item, generating one or more trade acceptance outputs to users involved in the trade.

The method can further include, upon receipt of an indication of acceptance by each user involved in the trade, outputting a trade verification to each user involved in the trade including shipping instructions.

The method can further include providing an interactive mechanism configured to allow each user involved in the trade to rate at least one other of the users involved in the trade.

The one or more trade acceptance outputs can include a rating associated with one or more other users involved in the trade

Generating the input mechanisms to enable the first user to initiate the trade can include generating for output a trade leg including data representative of the have item and the second item.

Generating the input mechanisms to enable the first user to initiate the trade can include generating for output a trade table including data representative of the have item and the second item including a two-dimensional matrix containing data representative of the have item and the second item.

The first tradable item can be a have item associated with the first user, and the method can further include providing an interactive mechanism configured to enable the first user to associate a condition with the have item.

The first tradable item can be a have item associated with the first user, and the method can further include providing an interactive mechanism configured to enable the first user to enter comments related to the have item.

The item identification can include an ISBN or a UPC.

Input of the item identification can cause an icon of the first tradable item to be automatically output.

The input mechanisms can enable the first user to input the item identification from one or more of a bar code reader, a text interface, a voice interface, touch screen, keypad, and interactive graphical mechanism.

The method can further include determining in real-time the at least one other tradable item that could be used in a trade involving the first tradable item.

The user interface can include at least one of a voice interface, an email interface, and a browser interface.

The method can further comprise providing an interactive mechanism configured to enable the first user to obtain a condition of a selected item from the other items.

The method can further comprise providing an interactive mechanism configured to enable the first user to obtain a rating of a second user associated with a second tradable item selected from the at least one other tradable item.

Generating the output indicating the at least one other tradable item can include generating user selectable icons representing the at least one other tradable item.

The method can further include, in response to selection of an icon representing a second tradable item from the at least one other tradable item, outputting item detail information related to the selected second tradable item.

The item detail information can include a selectable link that, when selected, generates an output indicating a set of tradable items, wherein any one tradable item from the set of tradable items could be used by the first user to obtain the selected second tradable item.

The item detail information can include a selectable link that, when selected, generates an output indicating a set of tradable items, wherein any one of the tradable items from the set of tradable items can be obtained by the first user in exchange for the selected tradable item.

The method can further include providing an interactive mechanism configured to output a trade history of the first user.

The method can further include providing an interactive mechanism configured to output trade-based performance statistics determined from a trade history of the second user from the at least one other user.

The method can further include providing an interactive mechanism configured to output recommendations of tradable items for the first user.

The recommendations can be determined based on a tradable item in at least one of a have list and a want list of the first user.

The recommendations can be categorized by content type from a set of content types, wherein the set of content types comprises one or more of books, music, movies, and video games.

The method can further include providing an interactive mechanism configured to output newly added have list items on have lists of a plurality of users.

The method can further include providing an interactive mechanism configured to output newly added want list items on want lists of a plurality of users.

In accordance with another aspect of the invention, provided is a computer program product configured for storage on at least one storage media and for execution by at least one processor to execute a method of generating a set of user interface mechanisms for presentation via a user device to facilitate automated trading of items among two or more users. The method comprises generating input mechanisms configured to receive an item identification for a first tradable item from a first user associated with an automated trading system. The method also includes, in response to receiving the item identification, generating an output indicating at least one other tradable item associated with a trade involving the first tradable item, wherein the at least one other tradable item is associated with at least one other user associated with the automated trading system.

The first tradable item can be a have item of the first user and generating the output can include determining the at least one other tradable item as have list items of the at least one other user that include the have item on their respective want lists.

The first tradable item can be a want item of the first user and generating the output can include determining the at least one other tradable item as want list items of other users that include the want item on their respective have lists.

The method can further include providing an interactive mechanism configured to output newly added have list items on have lists of a plurality of users.

The method can further include providing an interactive mechanism configured to output newly added want list items on want lists of a plurality of users.

The trade can be an N-way trade that includes more than two tradable items and more than two users associated with the more than two tradable items.

The input mechanisms can include mechanisms configured to enable the user to initiate a trade involving the first tradable item and a second item from the at least one other tradable item.

The method can further include providing an interactive mechanism configured to output recommendations of tradable items for the first user.

The recommendations can be categorized by content type from a set of content types, wherein the set of content types comprises one or more of books, music, movies, and video games.

In accordance with yet another aspect of the invention, provided is a user interface system configured to generate a set of user interface mechanisms for presentation via a user device to facilitate automated trading of items among two or more users. The system comprises an input module configured to generate input mechanisms configured to receive an item identification for a first tradable item from a first user associated with an automated trading system. And the system includes an output module configured, in response to input of the item identification, to generate an output indicating at least one other tradable item associated with a trade involving the first tradable item, wherein the at least one other tradable item is associated with at least one other user associated with the automated trading system.

The first tradable item can be a have item of the first user and the output module can be configured to generate the output of the at least one other tradable item as have list items of the at least one other user that include the have item on their respective want lists.

The first tradable item can be a want item of the first user and the output module can be configured to generate the output of the at least one other tradable item as want list items of other users that include the want item on their respective have lists.

The output module can be configured to provide an interactive mechanism configured to output newly added have list items on the have lists of a plurality of users.

The output module can be configured to provide an interactive mechanism configured to output newly added want list items on the want lists of a plurality of users.

The trade can be an N-way trade that includes more than two tradable items and more than two users associated with the more than two tradable items.

The input module can be configured to provide an interactive mechanism configured to enable the first user to initiate a trade involving the first item and a second item from the at least one of the other tradable item.

The output module can be configured to provide an interactive mechanism configured to output recommendations of tradable items for the first user.

The recommendations can be categorized by content type from a set of content types, wherein the set of content types comprises one or more of books, music, movies, and video games.

### BRIEF DESCRIPTION OF THE DRAWINGS

FIG. 1 illustrates a block diagram of a trading system according to an exemplary disclosed embodiment.

FIG. 2A illustrates a block diagram of a computer system according to an exemplary disclosed embodiment.

FIG. 2B illustrates a block diagram of a set of functional modules that can be executed using the computer system of FIG. 2A.

FIG. 3 illustrates a flowchart of a user interaction with an automated trading system according to an exemplary disclosed embodiment.

FIGS. 4-9 are examples of user interface screens that can be generated by the automated trading system.

### DETAILED DESCRIPTION

Systems and methods according to various aspects of the present disclosure facilitate or enable user interaction with trading systems and methods configured for automated exchanges of goods (generally referred to as “items” or “tradable items”) among a set of users. As used herein, the term “automated” includes semi-automated and fully automated systems and methods. In some embodiments, an automated trade can include a non-currency trade, a non-negotiated trade, or both. Below are illustrative embodiments of such systems and methods and systems and methods for user interaction with the foregoing. As will be appreciated by those skilled in the art, the present disclosure is not limited to the below illustrative embodiments, but can be implemented in a variety of embodiments not herein disclosed.

A user from the set of users can include any entity capable of making a trade, such as a person, a group of people, or an organization. In some embodiments a user could be an automated or programmed process configured to execute a trade. A group of people can include a family, a group of friends, a group of colleagues, members of a book club (or other club), alumni of an academic institution or any other group, whether related or unrelated. An organization can include a company, a business, an institution, a university, a non-profit organization, a department, an academic institution, a class, a hospital, a religious organization, a political party, a professional association, a governmental entity or any other organization.

In some embodiments, tradable items can include items of approximately similar value, but in other embodiments this need not be required. In some embodiments tradable items can include items having similar item properties, wherein item properties can include an item type or format, content type, condition, identifier—as just a few possible examples.

Item type can refer to one or more tangible forms or formats of an item, such as, for example, a book, a magazine, a compact disc (CD), a digital video disc (DVD), or other types of tangible expressions of content. It can also refer to an electronic file type, such as MPEG, JPEG, PDF, DOC, TIF and so on. In various embodiments, item type can also include classifications or sub-classifications of items, such as, for example, a hard-cover book, a soft-cover book, an audio book, an antique book, an out-of-print book, video games, application software, and so on. The item type could refer to other types of tangible objects or property, such as one or more of musical instruments, sporting goods equipment, art (or other collectibles), trading cards, clothes, vehicles, animals, computers, equipment, furniture or other personal property, as other examples.

In some embodiments, tradable items can include a special item, i.e., having a certain status relative to other items, wherein the special item can include items of higher or lower value than other tradable items. For example, special items can include a collection, such as, for example, a CD box set, a book series, a DVD box set, one or more collectible items, and so on. Special items can also include limited-editions, one-of-a-kind, autographed, event related items, rare items, or promotional items, as examples.

It is contemplated that item content can include any of a variety of content types or forms, such as text, an image (e.g., a picture, drawing, painting, and the like), an audio recording, a visual recording, an audio-visual recording, computer software (e.g., a game or software application), or any combination thereof, or other known types of content. Item content can additionally or alternatively, include indicia referring to whether the content is restricted, limited or rated content, such as adult only, G-Rated, and so on.

Item condition can refer to a condition of an item such as, for example, excellent, very good, good, average, poor, new, like new, used, damaged, small, medium, large, and so on.

In some embodiments, items can be associated with one or more item identifiers. For example, an item identifier can include a title, an author's or artist's name or pseudonym, a name of a group, a date, a volume number, a series number, an international standard book number (ISBN), a universal product code (UPC), a CD number, a DVD number, or other information associated with the item that distinguishes it individually or as being part of a certain class of items or genre. In some embodiments an identifier can be assigned by an automated trading system.

In some embodiments, an automated trading system can be configured to determine a trade of one or more items based on one or more properties of the items. For example, such a trading system can determine or identify a proposed or possible trade of items based on similar item type wherein a DVD can be traded for a DVD, a CD can be traded for a CD, a DVD box set can be traded for a DVD box set, and so on. The trading system can also determine a trade of items based on different item type, wherein a book can be traded for a CD, a DVD can be traded for a CD, and so on. In addition, the trading system can determine one or more trades comprising a plurality of items. For example, a book and a CD can be traded for two DVDs, six CDs can be traded for a CD box set, four magazines can be traded for a book, and so on. In various embodiments the automated trading system can facilitate any combination of the above trading scenarios.

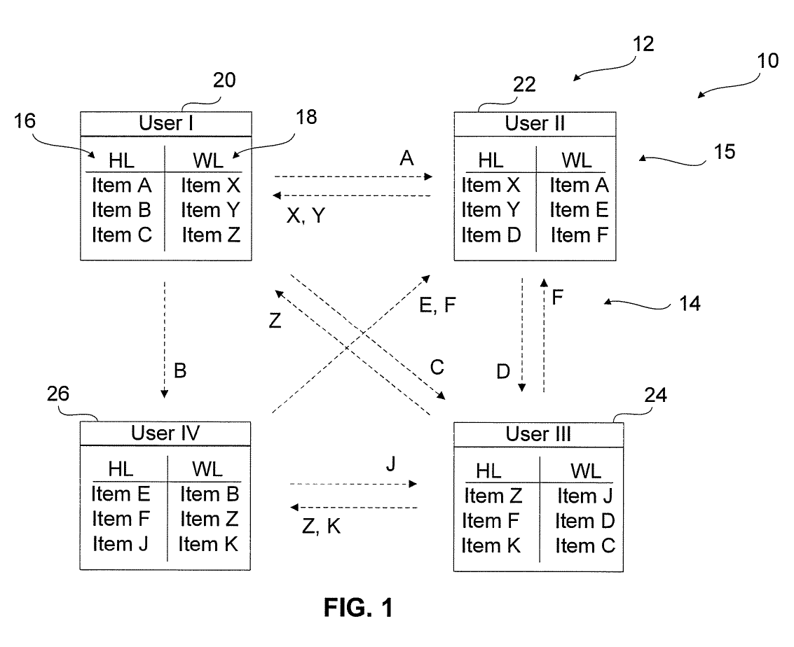

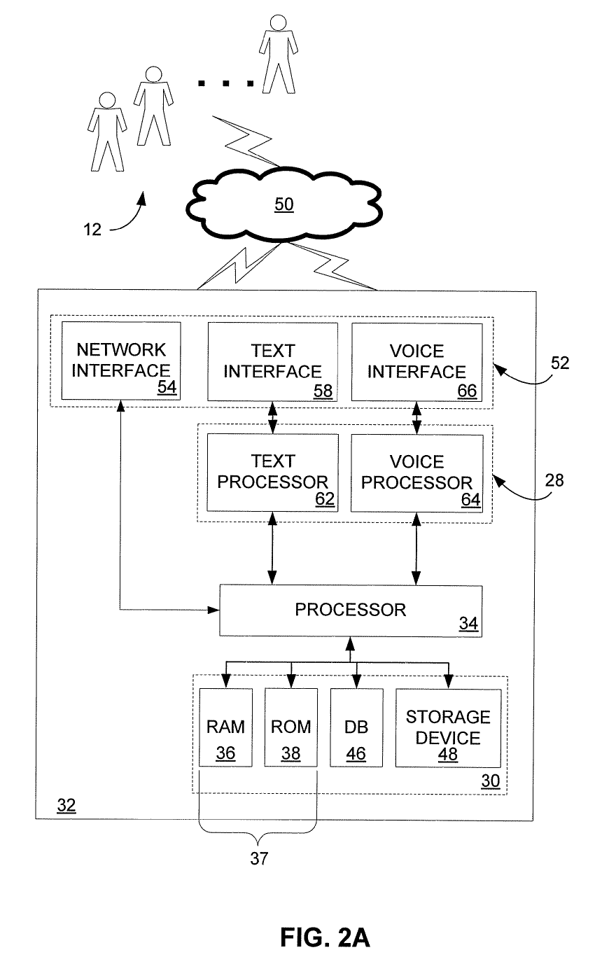

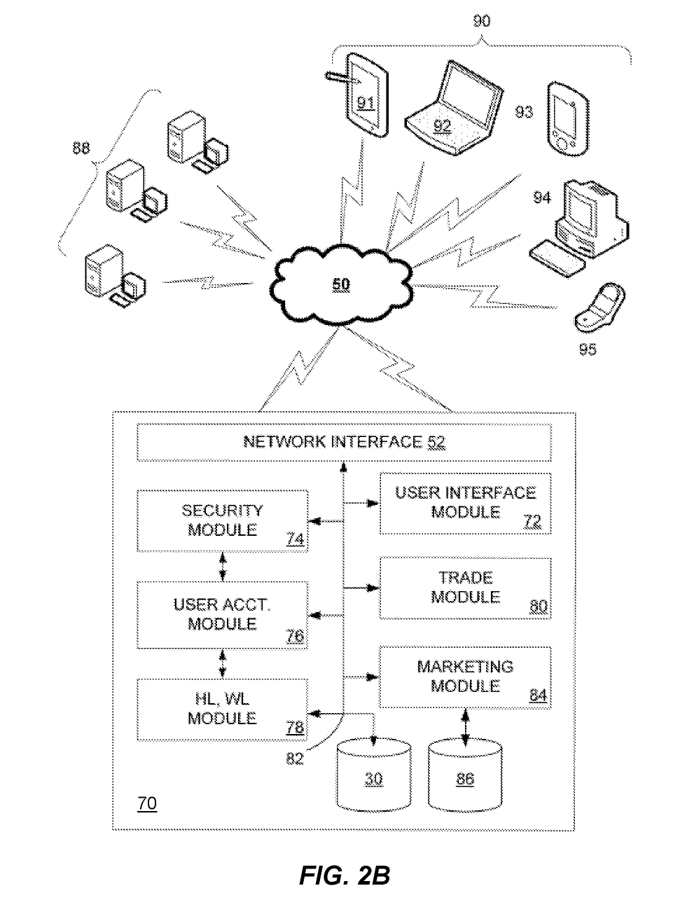

FIG. 1 is a representative block diagram 10 that conceptually represents possible interactions among a plurality of users 12 within the context of an automated trading system (see, for example, FIG. 2A and FIG. 2B). Through such interactions, a user can, for example, exchange one or more items it has for one or more items it wants that are held by one or more other users from users 12.

In the illustrative embodiment of FIG. 1, the plurality of users 12 includes a User I 20, a User II 22, a User III 24, and a User IV 26. Associated with each of these users can be a list 15, including a list of “haves” (e.g., a have list or “HL” 16) and a list of “wants” (e.g., a want list or “WL” 18). As is shown in FIG. 1, User I 20 has an HL comprising Items A, B, and C and a WL comprising Items X, Y, and Z. User II 22 has an HL comprising Items X, Y, and D and a WL comprising Items A, E, and F. User III 24 has an HL comprising Items Z, F, and K and a WL comprising Items J, D, and C. User IV 26 has an HL comprising Items E, F, and J and a WL comprising Items B, Z, and K. Each of these items is potentially eligible for a trade.

An automated trading system can be configured to determine at least one trade based on items listed in the HLs and WLs of the plurality of users 12. For example, the automated trading system can be configured to determine a two-way trade, wherein items can be traded between two users from the plurality of users 12 based on the HL and WL of each of the two users. As shown in FIG. 1, the automated trading system can identify or determine a two-way trade between User I 20 and User II 22, wherein User I 20 and User II 22 can trade Item A and Item X. For example, the automated trading system can determine that the HL of User I 20 includes Item A and the WL of User II 22 includes Item A. The trading system can also determine that the WL of User I 20 includes Item X and the HL of User II 22 includes Item X. The trading system can then facilitate or identify a trade between User I 20 and User II 22 whereby User I 20 can trade Item A to User II 22 in exchange for Item X. In FIG. 1 a trade is indicated by a dashed ray showing the direction of actual or proposed movement of an item from an HL or WL of one user to another user, along with an identification of the item (e.g., “A” for Item A).

Additionally, the automated trading system can be configured to determine an “N-way” trade, wherein a trade can involve more than two users and tradable items. In such embodiments N refers to the number of users participating in a trade, from the plurality of users. There is no inherent limit on the number of users that can be involved in a trade. For example, the automated trading system can be configured to determine a four-way trade, where N equals four, so involves four users.

As shown in FIG. 1, trading system can determine that User I 20 could trade Item B to User IV 26, User IV 26 could trade Item J to User III 24, User III 24 could trade Item F to User II 22, and User II 22 could trade Item Y to User I 20. This exemplary trade includes four users from the plurality of users 12, whereby four items are traded (or identified for a trade) based on the HLs and WLs of the four users. As another example shown in FIG. 1, the system can facilitate a three-way trade whereby User II 22 trades Item X and Item Y to User I 20, User I 20 trades Item A to User II 22 and trades Item B to User IV 26, and User IV 26 trades Item E to User II. Thus, it is not necessary that trades include one item for only one other item.

FIG. 2A is an exemplary block diagram of a computer architecture or system 32 within which an automated trading system (see FIG. 2B) can be implemented. The computer system 32 includes at least one processor 34 (e.g., a central processing unit (CPU)) that stores and retrieves data from an electronic information (e.g., data) storage system 30. As will be appreciated by those skilled in the art, while computer system 32 is shown with a specific set of components, various embodiments may not require all of these components and could include more than one of the components that are included, e.g., multiple processors. It is understood that the type, number and connections among and between the listed components are exemplary only and not intended to be limiting.

In the illustrative embodiment, processor 34 is referred to as CPU 34, which can include any of a variety of types of processors known in the art (or developed hereafter), such as a general purpose microprocessor, a digital signal processor or a microcontroller, or a combination thereof. CPU 34 can be operably coupled to storage systems 30 and configured to execute sequences of computer program instructions to perform various processes and functions associated with the automated trading system, including the storing, processing, formatting, manipulation and analysis of data associated with the automated trading system (e.g., user data, HL data, and WL data). The computer program instructions can be loaded into any one or more of the storage media depicted in storage system 30. One illustrative embodiment of functional modules embodying such computer program instructions is provided in FIG. 2B.

Storage system 30 can include any of a variety of semiconductor memories 37, such as, for example, random-access memory (RAM) 36, read-only memory (ROM) 38, a flash memory (not shown), or a memory card (not shown). The storage system 30 can also include at least one database 46, at least one storage device or system 48, or a combination thereof. Storage device 48 can include any type of mass storage media configured to store information and instructions that processor 34 needs to perform processes and functions associated with the automated trading system. As examples, data storage device 48 can include a disk storage system or a tape storage system. A disk storage system can include an optical or magnetic storage media, including, but not limited to a floppy drive, a zip drive, a hard drive, a “thumb” drive, a read/write CD ROM or other type of storage system or device. A tape storage system can include a magnetic, a physical, or other type of tape system.

While the embodiment of FIG. 2A shows the various storage devices collocated, they need not be as they could be remote to each other, to processor 34 or both. Storage system 30 can be maintained by a third party, can include any type of commercial or customized database 46, and can include one or more tools for analyzing data or other information contained therein.

In various embodiments, storage system 30 can be configured to store data representative of the users 12, items 14, or both. Data representative of users 12 can include data that is not specific to the automated trading system, such as a name, a delivery address, a zip code, a credit card number, a social security number, a phone number, an email address, or a combination thereof, as examples. Data representative of a user can include data associated with the user and the automated trading system, such as, for example, a username, a password, item list 15 (see FIG. 1), HL 16, WL 18, a trade history, a user rating or ranking, a user comment, a trading group, an average response time, an accept/decline trade percentage, a member or account number, an access code, and so on. Data representative of items 14 can include data associated with one or more item properties.

As an example, database 46 can include any hardware, software, or firmware, or any combination thereof, configured to store data. Specifically, database 46 can be configured to store data or information representative of one or more of the plurality of users 12, one or more of items 14, or both. In some embodiments, database 46 can include one or more fields, wherein a field can be an element of a database record in which one piece of information can be stored. In particular, a field can be configured to store an element of data representative of one or more of the users 12, one or more of items 14, or both.

In some embodiments, one or more storage device in the data storage system 30 (e.g., database 46) can be configured to store a “trade leg” (TL), a trade table, or other data associated with the automated trading system. The term “trade leg” as used herein means a trade interaction, such as the movement of Item A from User I to User II in FIG. 1. A trade table can take the form, in some embodiments, of a matrix that logs information related to or derived from potential, proposed or actual trades, including trade legs. Data associated with the trading system can be stored in storage system 30 using any suitable database format, such as, for example, a relational database, a hierarchical database, or any suitable schema. Data storage system 30 can be configured to store information in a format configured to enhance operations of CPU 34 or other functions of the automated trading system.

To illustrate TLs with an example as shown in FIG. 1, TLs between User I 20, User II 22, User III 24 and User IV 26 can include the following thirteen TLs shown in Table 1 below:

TABLE 1

| | | |
|---|---|---|
| User I | → | User II with Item A |
| User I | → | User III with Item C |
| User I | → | User IV with Item B |
| User II | → | User I with Item X |
| User II | → | User I with Item Y |
| User II | → | User III with Item D |
| User III | → | User I with Item Z |
| User III | → | User II with Item F |
| User III | → | User IV with Item Z |
| User III | → | User IV with Item K |
| User IV | → | User II with Item E |
| User IV | → | User II with Item F |
| User IV | → | User III with Item J |

Computer system 32 can include or interface with one or more security systems (not shown), configured to at least partially restrict or control access to one or more components of computer system 32. Security systems can include hardware, software, firmware or a combination thereof, such as, for example, a firewall, password protection software, user authentication software, encryption software and the like. In some embodiments, security systems can be configured to limit a function of the trading system, limit access to data associated with trading system, or both. Security systems can be configured to limit trading of certain items 14 by certain ones of the users 12, such as, for example, children. In some embodiments, computer system 32 can be configured so that select data contained within storage system 30 can be inaccessible to one or more of the users 12. Computer system 32 can also be configured to permit trading of items 14 only between select users from the plurality of users 12, such as, for example, between users attending the same school, users in the same city or geographic vicinity, users that are part of the same or aligned organizations, users above a certain age, users with certain access privileges, or any combination thereof, as examples.

Computer system 32 can include a network interface system or subsystem 54 configured to enable trade-related interactions with the plurality of users 12 via one or more network 50. As such, computer system 32 can be configured to transmit or receive, or both, one or more signals related to the functions of the automated trading system. A signal can include any generated and transmitted communication, such as, for example, a digital signal or an analogue signal. As examples, network 50 can be a local area network (LAN), wide area network (WAN), virtual private network (VPN), the World Wide Web, the Internet, voice over IP (VOIP) network, a telephone or cellular telephone network or any combination thereof. The communication of signals across network 50 can include any wired or wireless transmission paths.

To enable communications via network 50, computer system 32 can include a set of interfaces 52 and a set of processors 28, 34. The set of processors 28 can include a text processor 62 and a voice processor 64, along with CPU 34. The set of interfaces can include a network interface 54, a text interface 58 and a voice interface 66, as shown in this embodiment. As mentioned above, network 50 can represent a combination of networks configured to transmit and receive communications with computer system 32, via any of the set of interfaces 52.

CPU 34 can be operably coupled to network interface system 54 for exchanging typical computer network information, e.g., via the Internet, a LAN, WAN, VPN or some combination thereof. Network interface system 54 can be configured to permit communication between and among the users 12 and computer system 32, for example using an Internet protocol (IP) or other network-based protocol. In such cases, network interface system 54 can be configured to utilize TCP/IP, HTTP, DNS or any other application, transport, network, or link protocol, or combination of the foregoing.

Text interface 58 can be operably coupled to a text processor 62 configured to process received text message and text messages to be transmitted. Text interface 58 can be configured to permit text-based communication between users 12 and computer system 32. For example, in combination, text interface 58 and text processor 62 can include functionality to communicate with a two-way pager, a personal digital assistant (PDA), a cell phone, a computer, a laptop, a tablet, a terminal, or any other suitable electronic device, whether wired or wireless. Text processor 62 can include an email system configured to transmit, receive, or process, email messages or a combination thereof. Text processor 62 can also include an instant-messaging (IM) system, a two-way paging system or other system configured to transmit, receive, or process, or a combination thereof, text-based information. As will be appreciated by those skilled in the art, such systems can also provided mechanisms for transferring files between devices. Such files can include any of a wide variety of content.

Voice interface 66 can be operably coupled to a voice processor 64 configured to process received voice information and voice data to be transmitted. Voice interface 66 can be configured to permit voice-based communication between and among the users 12 and computer system 32. For example, in combination, voice interface 66 and voice processor 64 can be configured to enable interaction with a cell phone, a fixed-line telephone, a VOIP device or other similar device, or combinations thereof. For example, voice interface 66 can be configured to transmit, receive, or both digital or analogue signals using wired to wireless communications devices and systems, such systems can include telephone, cellular telephone and VOIP systems, as examples.

In some embodiments, the operable connections between components of computer system 32 can be other than as shown in FIG. 2A. For example, data storage system 30 can be operably connected to communication processors 28 or interfaces 52, or both, such that users from the plurality of users 12 can modify data stored in data storage system 30 using such interfaces and processors.

In various embodiments, systems that can be associated with the automated trading system can include one or more systems configured to provide additional functions associated or useful in conjunction with the trading system. For example, systems associated with the trading system can include a tracking system (not shown) configured to track the transport of traded items, a postage system (not shown) configured to provide postage services for shipping traded items, a routing system configured to route and re-route traded items, or other suitable systems. Computer system 32 can be configured to transmit one or more signals to one or more systems associated with the trading system. For example, a system associated with the trading system can be configured to receive a signal transmitted by computer system 32 wherein the signal can affect a function of the system associated with the automated trading system.

It is also contemplated that trading system can be implemented using one or more computer systems 32. For example, various embodiments of an automated trading system can include a plurality of computer systems 32, components of computer system 32, or other systems associated with the trading system. A large number of users 12, heavy trading, or complex computations can require relatively high computational power to efficiently operate the trading system. It is also contemplated that one or more automated trading system can be configured to operate independently of other trading systems based on a language, an organization, an age of users, a geographic location, or other requirement.

FIG. 2B is a block diagram of an embodiment of an automated trading system 70 that can be implemented using the computer system 32, as an example. Trading system 70 can include a variety of functional modules that communicate via a communication path 82, (e.g., a bus or a network). As discussed with respect to FIG. 2A, trading system 70 can communicate with a set of users (e.g., users 12 from FIG. 1) via network 50. In various embodiments, the users can access the automated trading system using any of a variety of wired or wireless devices 90. Such devices can include an electronic tablet 91, laptop computer 92, a PDA 93, a personal computer 94 or a cell phone 95, as examples.

Automated traded system 70 can include a user interface module 72 that can be configured to prepare information or content to be output via any of devices 90. Such information or content can be configured to be provided within a browser or window environment, and could include, as example, text, graphics, video, audio or the like. More specifically, information presented on the devices 90 can include information representing users, items 14 from HLs and WLs of the users 12 (or the HLs and WLs themselves), information related to a previous, proposed or possible trade, or other information associated with the automated trading system. User interface module 72 can also prepare information received via network interface 52 for use by the other modules of the trading system 70.

In the various embodiment of automated trading system 70, user interface module 72 can be configured to prepare and transmit (via the set of interfaces 52) a wide variety of signals for presentation via user devices 90. A signal transmitted using user interface module 72 can include any data associated with automated trading system 70. For example, a signal can contain data representative of at least a partial trade, data representative of users from the plurality of users 12, data representative of items from the plurality of items 14, or a combination thereof. A signal can also include a request for a user input, wherein user input can include any information communicated by a user to automated trading system 70. User input can include any data associated with users from the plurality of users 12, data representative of items from the plurality of items 14, or a combination thereof. A request for user input can include a request for the user to accept or decline (or reject) a possible trade determined by automated trading system 70. In some embodiments, a first signal can include a request for user input. The first signal can also include data representative of at least a partial trade, data representative of one or more users, data representative of one or more items, or a combination thereof.

A signal requesting user input can also include information representing a specific time period by which a user input can be required to respond to the signal. For example, the user can be given a specific time period (e.g., twenty-four hours) to respond to a trade request. If the user fails to respond to a trade request within the designated period, then the user can be removed from the possible trade, or the possible trade can otherwise be removed from a list of possible trades. The specific time period can include any appropriate time period, such as, for example, twelve, twenty-four, thirty-six, forty-eight, or seventy-two hours, or ten minutes, or by the end of the user's session. As will be appreciated by those skilled in the art, any possible timeframe or limit can be established. The specific time period can also be extendable, wherein automated trading system 70, at least one user can, under certain circumstances, extend the specific time period. In some situations the time limit could be a first-come first-served time limit.

User interface module 72 can also be configured to permit users to create, modify and delete data associated with automated trading system 70, e.g., typically stored in storage system 30. As examples, the user interface module 72 can be configured to permit a user to add items to and remove items from its HL, WL, or both. User interface module 72 can be configured to enable selection of one or more items from a list of items through graphic, voice, text or other interactions. Automated trading system 70 can then update the relevant data associated with the user and transmit signals to the user based on the update.

User interface module 72 can be configured to receive from the plurality of users 12 at least one user input following a request by the automated trading system 70 for the user input. For example, the user interface module 72 can receive a signal including data representative of a trade determined by automated trading system 70. Via set of interfaces 52, user interface module 72 can transmit signals configured for display on a user device, wherein the signals represent a possible trade involving the user and requesting a user response to the possible trade. In some embodiments, user interface module 72 can be configured to permit users to accept or decline (or reject) the trade. Specifically, user interface module 72 can include functionality to display within a browser or window an “Accept” and a “Decline” button, wherein user 12 can accept or decline a trade by selecting an appropriate button. In such a case, selection of a button causes a corresponding signal to be received and processed by automated trading system 70. Text interface 58 or voice interface 66 can also be configured to permit users 12 to transmit a user input to automated trading system 70, such as, for example, to accept or decline a trade based on a voice or text input from the user.

In some embodiments, automated trading system 70 can include a marketing module 84. The marketing module can be configured to provide advertisements to be displayed via user interface module 72. The advertisements can take any of a variety of forms, such as images, text, pop-ups, messages, email, voice messages, audio or any other advertisements known or developed in the future to be communicated to one or more users.

In some embodiments, marketing module 84 can provide advertisements based on user information associated with automated trading system 70. Advertisements can be displayed to a target group of users based on information associated with the target group of users. Users who have listed in their want or have list a specific item, several similar items, or certain quantities of items can form a target group of users. For example, if users list one or more books related to travel, advertisements can be shown for goods or services associated with the travel industry. In another example, a user listing a specific CD can be notified when that artist is performing locally, when that artist releases another CD or advertise CDs by that or similar artists.

Marketing module 84 can provide advertisements to users based on other information, such as demographic data, item and user data, trading data, or data generated by predictive systems. For example, predictive systems can predict that users who like a book by author A will also like a book by author B. It is also contemplated that advertisers can use other information associated with the users to define a target group. For example, users within a geographic location can receive advertisements from local providers of goods or services, whereas users of certain age, gender, alma mater, and so on, can receive advertisements targeted to those groups of users. Some advertisements can also be placed based on timing considerations, such as, for example, advertisements shown relating to an upcoming event.

A security module 74 can be included if access to trading system 70 and databases 30 are to be protected. As examples, security module 74 can include functionality to authenticate a user before allowing such access, such as by logging in using password protection. A user account module 76 can be included to permit the setup and management of user accounts, which can be stored in database 30. A user account can include information identifying the user, such as name, address, e-mail address and so on. Also associated with each user and its user account can be trade related information, such as have lists and want lists. In various embodiments, an HL, WL module 78 can be included for enabling users to define at least one have list and at least one want list. HL, WL module 78 can also maintain and update the HLs and WLs in database 30 in response to trades or user edits.

A trade module 80 is also included that provides the primary functions associated with identifying, coordinating and executing trades. To do so, trade module 80 accesses the HLs and WLs of various users in database 30 and searches for synergistic matches among such lists among the users. For example, for a given user (which can be a logged in user) and an identified item that the user wants, trade module 80 can search the have lists of other user in database 30 to determine which of the users has the identified item. As a result the trade module can identify one or more 2-way or N-way trades that could get the user the identified item, in exchange for at least one item on the user's want list.

Trade module 80 can present the potential 2-way or N-way trade items, e.g., graphically on a computer screen. In any event, trade module 80 can also present, or make accessible, item properties (e.g., new, used, damaged). In providing such information, automated trading system 70 can allow the user to select the most desirable trade for execution. Trade module 80 can also include functionality that requires each user to assent to the trade before it is executed. In some embodiments, trade module 80 can include functionality for generating signals embodying notices to users of a proposed trade involving one or more items from that user's have list or want list, e.g., an e-mail, phone call, and so on. The trade module can also be configured to provide a user a list of possible trades for items on the user's have list, i.e., showing what the user could get (even if not on the user's want list) for what the user has.

In generating lists of possible trades, the trade module 80 can determine a set of trade legs (TLs), trade tables or other information related to such possible trades, as discussed above with respect to FIG. 1. As will be appreciated by those skilled in the art, the modules present in FIG. 2B are merely illustrative. Other embodiments could use different modules that implement the disclosed functions in other manners, or could combine modules shown.

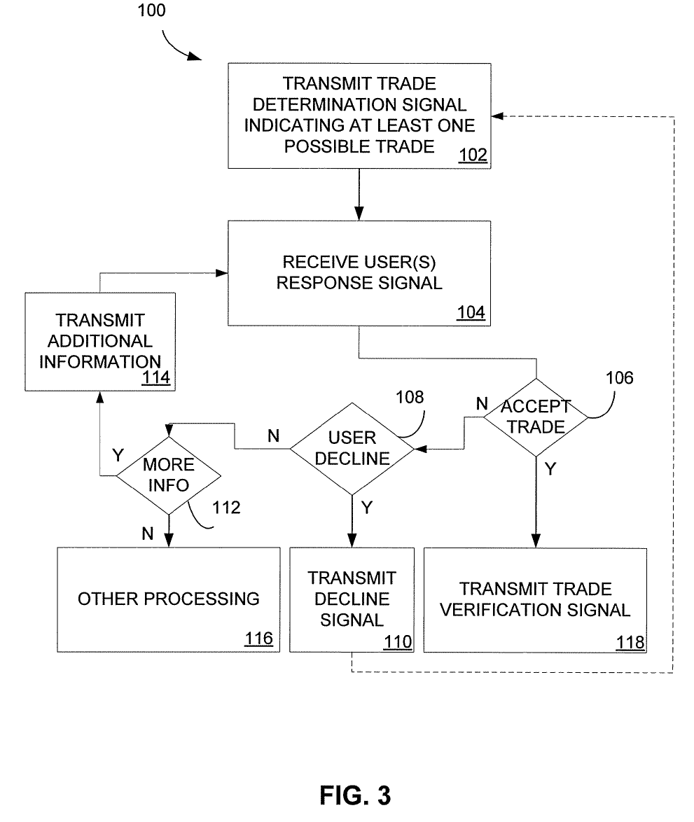

FIG. 3 illustrates a flowchart 100 of an exemplary method of user interaction with the automated trading system 70, e.g., to access, maintain, and review information related to the user, the user's trade history, possible new trades, and to initiate, review, participate in and manage new trades. More specifically, flowchart 100 represents a method for users among the plurality of users 12 to interact with an automated trading system to trade, consider trades involving one or more items 14, or add one or more items 14 to a have or want list, for example, using automated trading system 70 of FIG. 2B. Those skilled in the art will appreciate that the present disclosure is not limited to the method of FIG. 3.

Method 100 can be used to determine, propose and execute one or more automated trades based on the users' interaction with automated trading system 70. In some embodiments, such trades can be determined based on data and information representative of users 12, items 14, or both. Such data and information can be embodied in signals transmitted and received between users 12 and automated trading system 70. Communication between the users and the automated trading system can be accomplished using any of the previously mentioned devices, networks, protocols, interfaces and so on. In various embodiments, automated trading system 70 can be configured to transmit signals to users representing various pertinent information configured to be output in any of a variety of known, or hereafter developed, forms. For example, the transmitted signals can embody information suitable for presentation via a screen of at least one of a laptop, PC, PDA, network enabled television, cell phone and the like, via an audio output of any of the foregoing, or some combination thereof.

According to method 100 of FIG. 3, it is presumed that automated trading system 70 has determined one or more possible trades involving two or more users from the plurality of users 12 and involving a set of items from items 14, as previously described. Trade determination can be performed in response to receipt by automated trading system 70 of a signal received from at least one user prompting determination of at least one trade. While such a step is not shown in FIG. 3, it could optionally be included. In some cases, the prompt signal received by automated trading system 70 can be a real-time signal transmitted by a user, while in other cases the prompt signal could have been an earlier transmitted signal establishing parameters for determining a trade. In other situations, trade determination could be prompted by the automated trading system 70, without prompting by a user, e.g., based on the HLs and WLs of the users. In other embodiments, a third party system could transmit a signal to automated trading system 70 to initiate one or more steps of method 100.

Each of the possible trades provides at least one path for one user to send or receive at least one of item to or from at least one other user. As previously discussed, automated trade system 70 can determine a trade, whether 2-way or N-way, in any of a variety of manners. For instance, in the embodiment of FIG. 3 it can be presumed that the information representing a set of tradable items the user wants and a set of tradable items the user has are stored in, or at least accessible by, the automated trading system 70, perhaps stored in storage system 30. The have and want tradable item information can take the form of have lists 16 and want lists 18 for each of the plurality of users 12. In various embodiments, automated trading system 70 can be configured to transmit signals to users embodying information, data, code, or a combination thereof representing the tradable have and want items for presentation via a user device, for example in the form of a proposed trade.

In a first step 102, automated trading system 70 can transmit to at least one user from the set of users 12 one or more trade determination signals representing a trade, such as, for example, a proposed or an accepted trade. The trade determination signals can include any of a variety of information, such as, for example, a trade alert that prompts the user to access automated trading system 70 to review the proposed trade, information related to the proposed trade, or a combination thereof. These signals can include, as examples, information representing one or more users involved in the proposed trade, the set of tradable items included in the proposed trade, data, information, or code prompting the users to assent to or decline the proposed trade, or combinations thereof. Various other information could also be transmitted. For example, the trade determination signals can also include user selectable links to related information, data or functions of automated trading system 70.

In step 104, automated system 70 can receive at least one response signal from at least one user that is based on the trade determination signal of step 102. The user response signal can include information, data, instructions or some combination thereof related to the proposed trade. For example, the response signal can indicate that the user has selected, assented to, requested further information about, or declined the proposed trade. For a proposed trade, the response signal can include a user request for more information relating to tradable items (e.g., tradable item properties), the users involved, or a combination thereof.

Automated trading system 70 can be configured to perform one or more processes based on information included in one or more received signals. For example, automated trading system 70 can be configured to perform a process based on a received user signal, e.g., a user input. A user input can include one or more steps, wherein a step can include a user action. For example, user input can include a single step, wherein the user can perform a single task, such as, selecting a button, clicking a check box, entering a single username, password or access code, or other action. User input can also include multiple steps, e.g., wherein a user can perform two or more single tasks. Two steps can include selecting an item from a list of items to trade and accepting the trade, declining a trade and selecting a reason for declining the trade, or accepting a trade and then authorizing the trade. It is also contemplated that user input can include three or more steps, such as, for example, accepting a trade, authorizing the trade, specifying a delivery address, or accepting a trade, authorizing the trade, and specifying an item to receive.

In step 106, based on processing of the user response signal, if the user did not accept (or assent to) the proposed trade, the automated trading system 70 determines if the user declined the trade, in step 108. A lack of response, particularly if a response time has been set, can be processed as declining a trade. If declined, the automated trading system 70 can transmit a signal acknowledging the declined trade, in step 110. The automated trading system can (optionally) update and transmit a new trade determination signal by returning to step 102, as indicated by the dashed line, whereby the method can the be repeated based on a different trade, a canceled trade, or other suitable information.

If in step 108, the user did not decline the trade, then the method can continue to step 112, where a determination is made, based on the user response signal, if the user requested more information. If so, in step 114, the additional information can be transmitted to automated trading system 70. The method can then continue to step 104 upon receipt of a user response to the additional information. The method can then continue to step 106 again. However, if in step 112 it was determined that the user response signal did not include a request for additional information, then the method can continue to step 116 to process or otherwise respond to whatever information, data, or instructions were included in the user response signal of step 104.

Returning to step 106, if the user did accept the proposed trade, then the process continues to step 118, where upon satisfaction of all criteria for the execution of the proposed trade, automated trading system 70 executes the trade. As a result, trading system 70 transmits, in step 118, a trade verification signal to one of more of the users involved in the agreed to trade. In various embodiments, it can be required that each user involved in a proposed trade affirmatively accept the trade before it can be executed. In such cases the automated trading system 70 can transmit signals prompting each user to accept the trade, which could be accomplished with the trade determination signal of step 102. In other embodiments, not all users involved with a proposed trade need to affirmatively accept the proposed trade as a criterion for executing the trade. In some cases, users could indicate acceptance in advance, without ever having received a trade determination signal. For example, the automated trading system 70 can be configured to receive signals from user devices that allow the user to set up a pre-approved trade. Such a trade can be executed automatically as soon as the user's criteria for the trade are satisfied, e.g., as soon as a copy of a certain book (e.g., on the user's want list) becomes available for trade for an item that the user has (e.g., on the user's have list).

Using the computer system 32 and automated trading system 70 as examples, a series of trade-related communications between users 12 and automated trading system 70 will be described by way of example. In order for a user to gain access, trading system 70 can be configured such that the user must provide a form of identification or access code to authenticate and gain access. It is also contemplated that trading system 70 can be configured to determine an identity of the user using other methods, such as, for example, using cookies, personal information associated with a cell phone, or other methods known in the art. If access is controlled, submission of appropriate data can allow the user to access trading system 70.

Following access to trading system 70, the user can then access data representative of itself, its listed items, trade history, and so on. Such data can be stored in storage system 30 and associated with a user account. Using trading system 70, the user could also view, add, delete or edit data associated with it or its account. For example, the user can add or remove items from its HL, WL, or both (see FIG. 1). If the user accesses trading system 70 via network interface 54, the system can be configured to permit the user to add items to its HL, WL or both using a graphical user interface (GUI) browser. The updated data associated with the user can then be stored using storage system 30. It is also contemplated that additional, fewer or different steps can be conducted when the user accesses trading system 70 for the first time, e.g., for account setup, or initial generation of the user's HL, WL or both.

In some embodiments, automated trading can include any form of trading, such as non-currency trading, non-negotiated trading, quasi-currency trading or a combination thereof. Non-currency trading can include trading that does not require a net transfer of currency between users participating in a trade. But, in some embodiments, trading system 70 can include membership fees, postage fees, or other currency transfers between trading system 70 and the users. Currency can include cash, credit, debt, bonds, stock, options, or other financial valuations of item. Currency can also include quasi-currency, such as a token or other proprietary currency used to represent the worth of items.

Non-negotiated trading can include trading that does not require a negotiation between users participating in a trade. Traditional forms of trading often require negotiation, bargaining, or other forms of communication between trade participants. Generally, a trade would only be agreed to upon the satisfaction of all trade participants, the basis of the agreement would often be the values of the items being exchanged. In non-negotiated trading, the users involved in a proposed trade do not interact to determine values of items associated with the trade. In fact, the users can be prevented from interacting, except for post-trade execution transfer of the traded items. Non-negotiated trading can alleviate a significant amount of anxiety associated with bartering and expedite the trade significantly. Thus, non-negotiated trading tends to entice more users to trade and to make those trades much more efficient.

In some embodiments, the automated trading system 70 can be configured for determining or identifying one or more trades based on one or more trade-legs (TLs). For example, a TL can include data representative of a one-way transfer of an item between a first user and a second user, as is discussed with respect to FIG. 1 and Table 1. In some embodiments, the automated trading system 70 can be configured for determining a TL based on items listed in the HL, WL or both of users involved. For example, a TL can represent an item and two users, wherein a first user can have the item listed on its HL and the second user can have the same item listed in its WL. FIG. 1 and its associated text discusses proposed trades, and their trade legs.

In some embodiments, the automated trading system 70 can be configured for determining one or more automated trades based on a trade table. The trade table can implement any suitable data format, wherein data associated with trading system 70 can be stored in multi-dimensional format, such as, for example, a two-dimensional matrix. The trade table in the two-dimensional matrix format can include data representative of one or more items listed in one or more columns and rows of the trade table. In some embodiments, the trade table can include a header row containing a list of items, wherein one or more of the cells of the header row can contain one item. In some embodiments, the trade table can also include a first column containing a list of items, wherein each cell of the first column can contain at least one item. Further, the cells of the trade table can include data representative of one or more users, wherein each cell can include at least one have or want item corresponding to one of items listed in the header row, one of items listed in the first column, or both.

The automated trading system 70 can also be configured for determining an automated trade based on a recommendation system, such as, for example, a collaborative filter, a recommendation engine, a neural network, or other suitable computational method. A recommendation system can include hardware, software, firmware or a combination thereof configured to determine a recommendation based data associated with trading system 70, and can be included as part of the system, e.g., included in trade module 80. For example, an item can be recommended to a user from the plurality of users 12 based on the user's HL, WL, a trade history, or other data associated with that user. It is also contemplated that if the user has no items listed in its WL, automated trading system 70 can recommend an item based on the user's HL or trade history. For example, trading system 70 can recommend an unlisted book by the same author as a book listed in the user's HL, an unlisted movie of similar genre to a movie previously traded, an unlisted CD by an artist listed in the user's HL, and so on. It is also contemplated that automated trading system 70 can recommend an item based on the items associated with others users deemed to have similar interests.

The automated trading system 70 can be configured for determining a trade with certain time-related parameters. For example, the automated system 70 can be configured to determine an automated trade in real-time, or near real-time. In some embodiments, real-time can include any time during a user's browsing session. Real-time can also include any time less than some predetermined threshold, e.g., ten minutes, and more typically, shorter times, such as sixty seconds or less. It is also contemplated that automated system 70 can be configured to determine an automated trade when a user is not logged into the automated trade system 70 or when the number of users accessing trading system 70 is below a threshold number of users.

Following the determination of one or more proposed automated trades, the automated trading system 70 can be configured to transmit one or more signals, as discussed with respect to the exemplary method of FIG. 3 above. A signal transmitted by automated trading system 70 can contain any data associated with the trade, users, items, or trading system 70. As previously described, the automated trading system can be configured to transmit signals via communication processors and interfaces 52, 28, 34 and 72 (see FIG. 2A and FIG. 2B). Specifically, the CPU 34 and communication processors 28 can generate signals for transmission via the set of interfaces 52. For example, the signals can be transmitted to interfaces 52 such that users participating in a trade can be notified of the trade.

In some embodiments, the signals can be transmitted based on an at least a partial trade determination. For example, signals can contain data representative of items to be traded and a delivery address to which a trade item is to be sent. The signals can also contain information representative of items to be received, such as, for example, an item title, condition, identifier, genre and so on, a rating of the user sending the item, a geographic location from where the traded item was or is being shipped, or other useful or suitable information. It is also contemplated that the signals can include a request for user input, such as, for example, a request for a user to accept or decline a trade.

In some embodiments, automated trading system 70 can be configured for transmitting signals to one or more systems associated with trading system 70. For example, automated trading system 70 can be configured to transmit one or more signals to a tracking system, a postage system, a shipping system, a system of an organization or other system. Specifically, signals can be transmitted to a tracking system to initiate tracking of traded items. It is also contemplated that signals can be transmitted to a postage or shipping system such that a user sending a traded item can be provided with a delivery address and appropriate postage.

Automated trading system 70 can perform a trade verification process based on a user input. Trade verification, as discussed with respect to step 118 of FIG. 3, can include a process for verifying an identity at least one user involved in the trade, an availability of at least one item to be traded, at least one delivery address, or other characteristics associated with the trade. Trade verification can also include verification of the authority of a user to trade an item. For example, the user might not be authorized to receive the item intended to be received upon trade execution, such as, a person under age requesting a trade for item that is age-restricted.

In some embodiments, trade verification can be based on one or more user inputs, wherein the user can submit information to automated trading system 70, such as, for example, a password, a personal identification number, a social security number, or other data associated with automated trading system 70. Automated trading system 70 can compare submitted information with information stored in storage system 30 to authenticate or verify the identification of the user. Trade verification can also include the user selecting one or more items to trade, one or more users to trade with, or other suitable user input.

Trade verification can also be based on an automated process, whereby verification information can be automatically provided to automated trading system 70. For example, a browser cookie can automatically provide identity information of a user or a phone number can be associated with identity information of the user. It is also contemplated that secure communication systems and other systems known in the art can be configured to automatically provide information to automated trading system 70 for determining a trade verification without additional user input. Automated trade verification can permit automated trading system 70 to determine a trade based on a single user input, as described above, such as, for example, based on a single click of a user selectable device (e.g., a button) provided by user interface module 72.

Automated trading system 70 can be configured to transmit one or more signals based on data included in one or more received signals. It is also contemplated that automated trading system 70 can be configured to transmit one or more signals based on one or more processes performed by automated trading system 70. It is further contemplated that automated trading system 70 can be configured to transmit one or more signals based on data included in one or more received signals and one or more processes performed by automated trading system 70.

In some embodiments, the automated trading system 70 can be configured for transmitting one or more signals based on information received from users from the plurality of users 12 and one or more systems associated with automated trading system 70. For example, automated trading system 70 can determine if one or more users from the plurality of users 12 have accepted or declined a proposed trade based on user input, as described above. If a proposed trade is declined by a user, automated trade system 70 can transmit a signal to cause data associated with the users involved in the proposed trade to be updated to reflect the decline. Alternatively, if a proposed trade is accepted by the involved users, automated trading system 70 can transmit signals to cause data associated with the involved users to be generated or updated. For example, such signals could include or embody a notification to the users to ship their respective traded items, shipping labels could be provided to the users, and the shipping of the traded items could be tracked, and so on.

In some embodiments, automated trading system 70 can be configured to transmit a subsequent signal based on a trade verification and a user input. Automated trading system 70 can determine a trade verification wherein the identity of the user is confirmed and the authority to trade item is confirmed. If the user is not verified to trade based on certain criteria, automated trading system 70 can transmit a signal notifying the user. For example, the signal can contain data to notify the user that the verification information submitted was incorrect, the user is not authorized to transact the trade, delivery information is required, or a previous trade is outstanding.

If the user is verified to trade, then automated trading system 70 can process user inputs communicated via user interface module 72, as described above. For example, automated trading system 70 can determine if the user input includes a trade acceptance and, based on this determination, can transmit a subsequent signal. The subsequent signal can be transmitted to notify the user of its trade acceptance, notify the user of the trade, update data stored in storage system 30, initiate tracking of traded items, or any other suitable action associated with trade initiation, conduct or execution.

If user input represents declination of a proposed trade, then automated trading system 70 can transmit a subsequent signal requesting additional input from the user, initiating another trade determination not including the user, re-routing items between users, or any other process associated with automated trading system 70. It is also contemplated that the user input can include pausing a trade, whereby the user can request that a trade be put on “hold.” In response to the “hold” request, automated trading system 70 can transmit a subsequent signal associated with pausing the trade.

In some embodiments, automated trading system 70 can be configured such that if it does not receive a user input from a user within a specified time period, the user can be removed from the trade. Automated trading system 70 can also extend the specific time period to provide additional time for one or more users to respond to a trade request. For example, a user input can be a request for time extension. Automated trading system 70 can grant or deny the user request for a time extension based on data associated with user, items being traded, such as, for example, a trade history, accept/decline percentage, user ranking, and so on.

The present disclosure provides a system and method for a user interactively trading one or more items between one or more users. Previous trading systems and methods and their user interaction capabilities were often complicated, time consuming, or difficult to use. The presently disclosed systems and methods can improve the ease-of-use, efficiency, or other aspects associated with trading items.

The user interaction via the automated trading method and system presently disclosed can include non-negotiated trading, wherein users are not required to negotiate to transact a trade. For example, through communications with the automated trading system 70, the users could either accept or decline a trade without any other required interaction, saving time and avoiding a lengthy bargaining process. The users can be allowed to interact with the automated trading system 70 to engage in non-currency trading, wherein items can be traded for other exchangeable items or items of similar value without currency changing hands. Users can save time by not assigning a value to items they wish to trade and avoid the use of quasi-currency systems. Such quasi-currency systems are often problematic as they are restricted in use and people can be reluctant to trust the long-term worth of quasi-currencies.

In some embodiments, automated trading system 70 can be configured to optimize the number of traded items, the number of users, or both participating in a trade. As previously described, automated trading system 70 can be configured to determine one or more N-way trades, which could maximize the number of items to be traded between users. Thus, if a 2-way trade and a 4-way trade are both possible, the automated trading system 70 could propose the 4-way trade to involve more users.

Another advantage of the presently disclosed system and method can be the increased likelihood that users will participate in trades, particularly through the ease, clarity and efficiency of user interactions. The presently disclosed system can encourage a user to participate in a trade by displaying items available for trade in real-time. For example, automated trading system 70 can be configured to determine one or more trades when the user accesses the system, or at any time during the user's session. Through its interaction with the automate trading system, the user can add an item to its HL and automated trading system 70 can then determine other items that the user can then receive in exchange for the newly added item. It is also contemplated that automated trading system 70 can transmit signals to the user for display of other items that the user could receive before adding a new item to its HL, even if other items are not in its WL. The user can add and remove items from its HL and WL as desired.

Another advantage of the presently disclosed system and method can be minimizing user input. In particular, the presently disclosed system and method aim to reduce the number of steps required by one or more of the plurality of users 12 to transact a trade. For example, users can be notified of a trade via email. Users can then respond to the trade notification with a single step, such as, accepting or declining the trade. If a user accepts the trade, a browser can open for accessing automated trading system 70. Automated trading system 70 can then verify the identity of the user, and can then request the user authorize the trade by providing a password. Automated trading system 70 can then initiate the trade based on the two step user input. It is also contemplated that automated trading system 70 can require a third user input before initiating a trade, whereby the third user input includes selecting a delivery address, a user to trade with, an item to trade, or a combination thereof.

In some embodiments, automated trading system 70 and associated systems can function to make trades based on a single click, a double click, other multiple input scheme. Such a simple and time efficient method can allow increased trading and reduce the likelihood that users 12 will not complete a trade or not be inclined to trade.

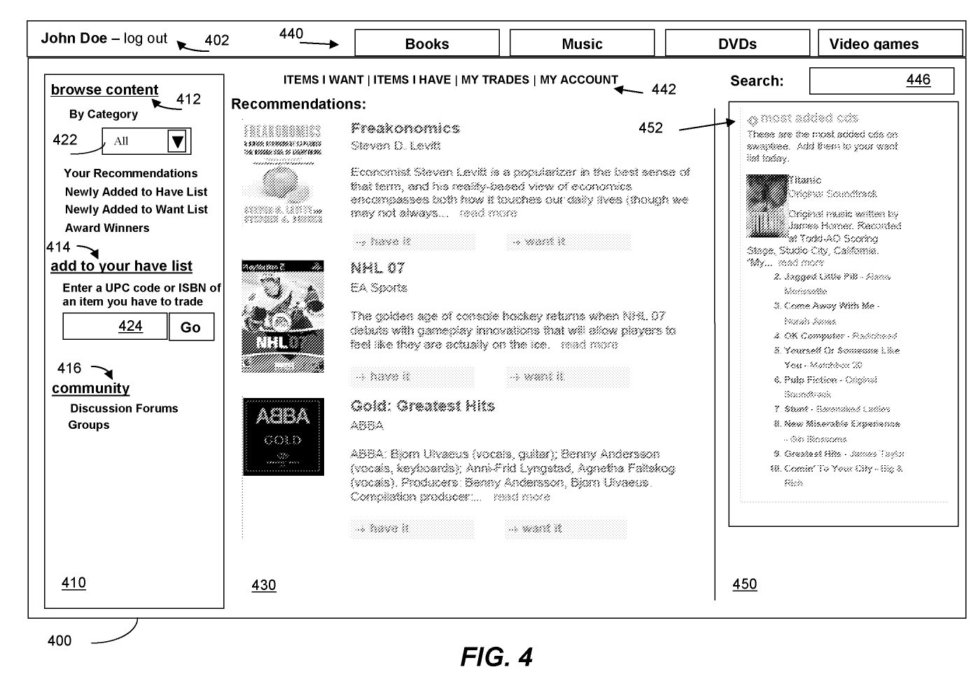

FIGS. 4-9 provide examples of user interface screens that can be produced by automated trading system 70. These screens represent possible embodiments, but are not limiting of the present disclosure. Those skilled in the art will appreciate that user interface screens could take other forms without departing from the present invention.

FIG. 4 is an example of a user home page screen 400 that can be generated within a Web browser once a user (e.g., John Doe) has logged into an automated trading system. In this embodiment, the text “log out” 402 is active, and logs out the user John Doe upon selection. A basic layout of home page screen 400 includes a sidebar area 410, which includes a variety of textual links and menus within corresponding topics, and a main area 430 for presentation of the primary content of the screen.

A first topic in sidebar area 410 is “browse content” 412, which provides various mechanisms for viewing different types of content related to tradable items. In this example, “By Category” includes a drop-down menu 422 that enables a user to select a category of tradable items to review. In this embodiment, the categories are books, music, DVDs (e.g., movies), and video games. In other embodiments the categories could be different. The default of the drop-down menu 422 is “All,” which means recommendations in all categories, i.e., books, music, DVDs (e.g., movies), and video games. Related to these categories are other drop-down menu choices that enable a user to selectively view recommendations in one of the categories: books, music, DVDs, and video games. In any of the foregoing cases, the tradable items presented in main area 430 are recommendations for the user, i.e., John Doe, in the indicated category or categories. These recommendations can be provided based on information about the user, which can include information related to the user's interests. User interests can be input by the user as part of its account or determined based, at least in part, on one or more of the user's have list, want list, and trade history.

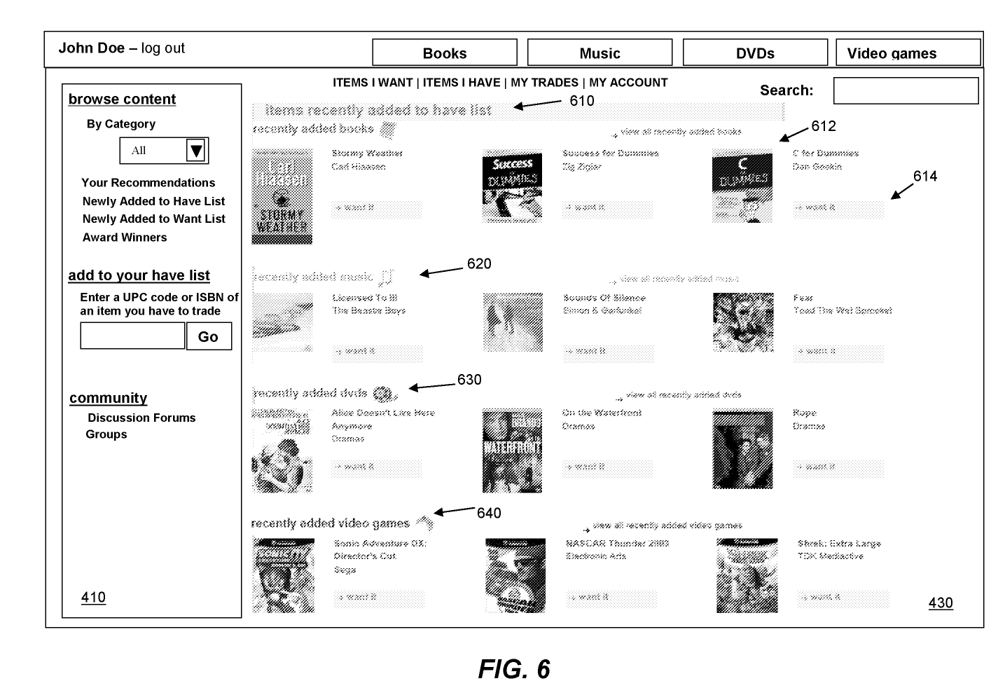

The browse content topic 412 also includes a selectable link entitled “Your Recommendations.” When the content of area 430 has been changed by a user migrating to a different screen or page, this link allows the user to change the content in area 430 back to the recommendations shown in FIG. 4. The browse content topic 412 also includes a selectable link entitled “Newly Added to Have List.” (See, e.g., FIG. 6) When selected, this link causes tradable items that other users have added to their have lists to be displayed in main area 430. The browse content topic 412 also includes a selectable link entitled “Newly Added to Want List.” When selected, this link causes tradable items that other users have added to their want list to be displayed in main area 430. The browse content topic 412 also includes a selectable link entitled “Award Winners.” When selected, this link causes tradable items that have won awards to be displayed in main area 430, and can include indicia of the awards.

Sidebar area 410 also includes a topic labeled “add to your have list” 414. As suggested, this item includes a field 424 for input of a UPC or ISBN for an item the user has and wants to add to its have list. Entering the UPC or ISBN and selecting “Go” causes the item to be added to the user's have list.

Optionally, sidebar area 410 can include a topic “Community” 416. Under this topic, a selectable link labeled “Discussion Forums” causes main area 430 to transition to a user input page for conducting dialog with other users, for example. Under this topic, a selectable link labeled “Groups” causes main area 430 to transition to a page that identifies different user groups. That is, users can join or form groups. For example, groups can be defined geographically, e.g., Boston area, or organizationally, e.g., for a university. There is no inherent limit on the types of groups that can be formed.

Each tab in a set of tabs 440 can be user selectable. The set of tabs 440 can include a tab for each category, in this case books, music, DVDs, and video games. Selection of a tab causes the corresponding recommendations to be displayed in main area 430—like the selectable categories in drop-down menu 422. Across the top of main area 430 is a set selectable links 442 that allow the user to migrate to certain ones of its pages. In this case, the set of links includes a link “Items I Want” which causes the user's want list to be displayed in main area 430; “Items I Have” which causes the user's have list to be displayed in main area 430; “My Trades” which causes the user's trade history to be displayed in main area; and “My Account” which causes the user's account information to be displayed in main area 430. A text search mechanism 446 can also be included to allow a user to conduct a text-based search, e.g., for a specific tradable item or for tradable items by a particular artist or author.

In FIG. 4, recommendations for “All” categories are shown in main area 430. In this example, these recommendations include the book Freakonomics, the video game NHL 07, and the music CD ABBA Gold. In each case, two active buttons are provided that enable the user to add the item to the user's have list or want list, i.e., the buttons “? have it” and “? want it.” These buttons transition main area 430 to the corresponding have list and want list pages and can be configured to allow the user to add the item to the appropriate list without entering UPC or ISBN information.

FIG. 4 also shows an optional secondary area 450, which in this case includes a list of the “most added cds” 452. This information informs the user that there are many possible trades involving these items.

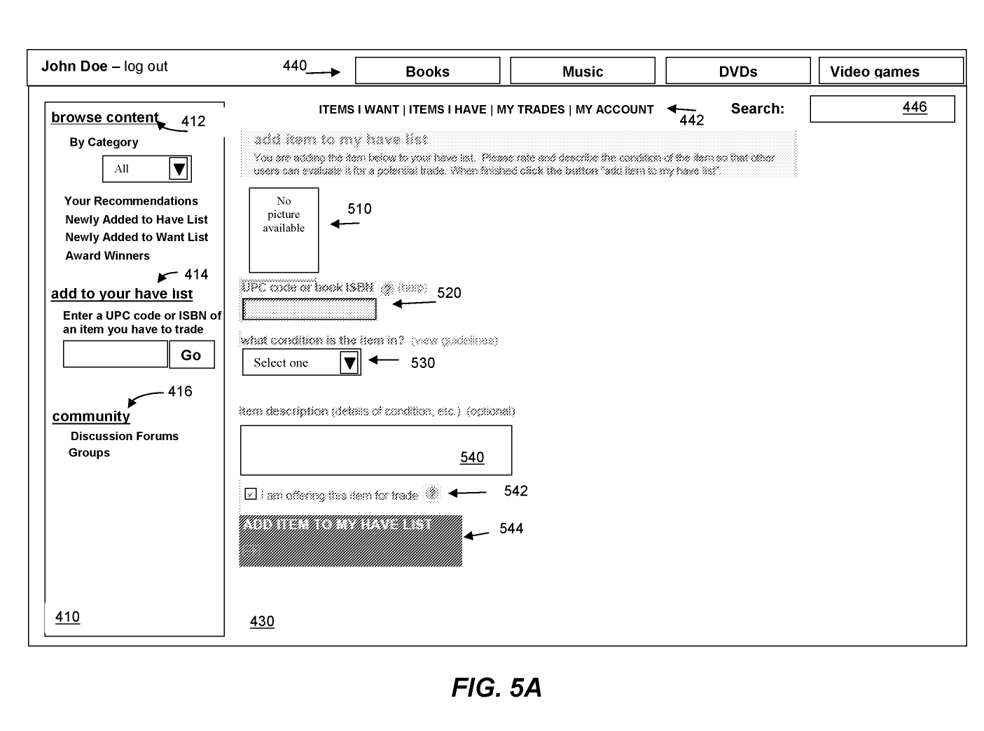

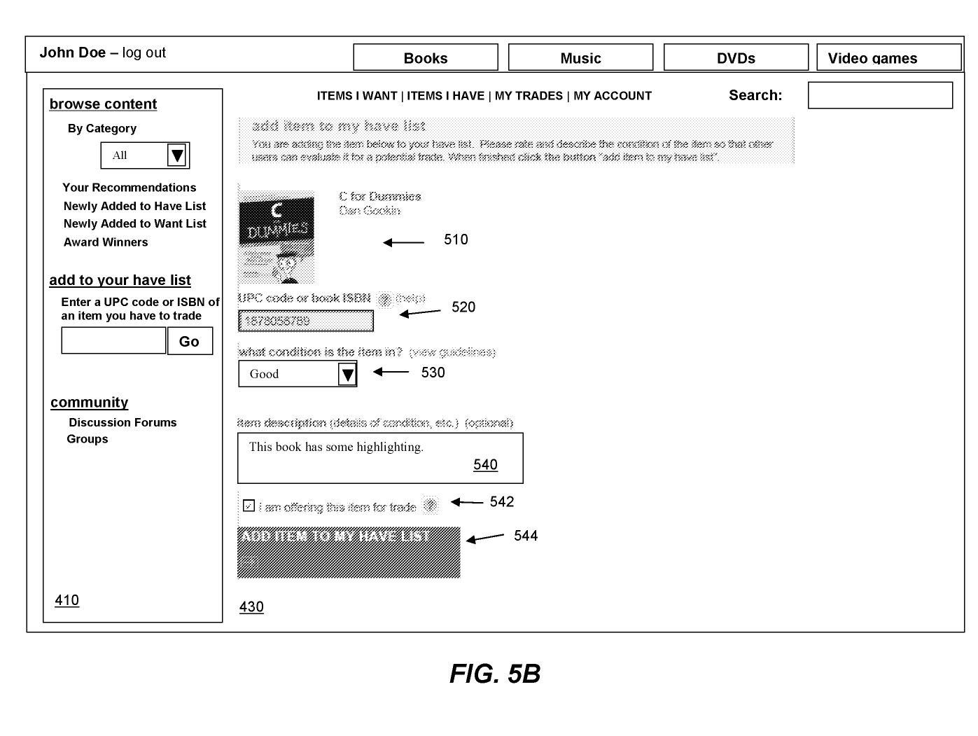

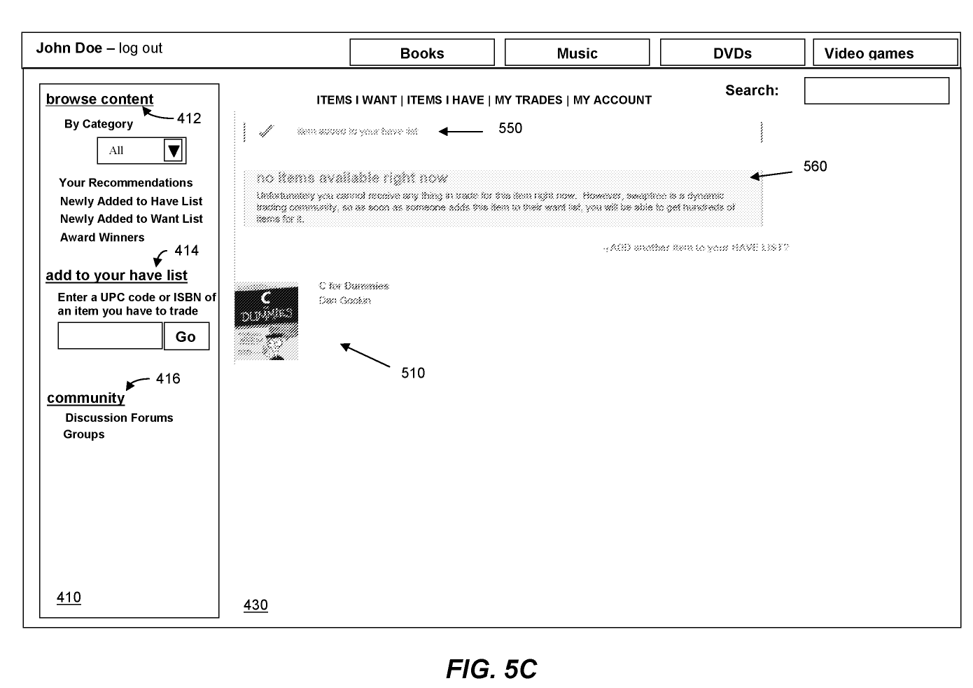

FIG. 5A is a view of a page that can be displayed in main area 430, e.g., by selecting the “Go” button under the topic “add to your have list” 414. This page includes a variety of mechanisms configured to enable a user to add an item to its have list. A picture field 510 is provided for a display of a picture of an input item, e.g., a cover of a book, CD, DVD, or video game. An item identification field 520 is provided for entry of a UPC or ISBN, as the primary mechanism for identifying the new tradable item to be added to the user's have list. Once input, a picture of the item appears in picture field 510, if available. A condition identification field 530 is provided to allow the user to identify the condition of the item to be added. In this embodiment, field 530 is a pull-down menu that allows the user to select a condition from among: new, like new, very good, good, and acceptable. A free text field 540 can also be included to enable the user to enter other description details for the item. All of the foregoing information is preferably made available to another user interested in trading for the item. In this embodiment, a check box 542 is included for the user to indicate that it is offering the item for trade. And a button 544 is included to add the above indicated item to the user's have list. The UPS of ISBN could also be input to field 520 through a bar code scanner, in which case the UPC or ISBN would appear in field 520 and, if available, a picture of the cover of the item would appear in picture filed 510.

FIG. 5B is a view of the page of FIG. 5A with information added. In FIG. 5B the ISBN “1878058789” was entered into item identification field 520, which is the ISBN for the book C for Dummies by Dan Gookin. Once the ISBN is input, a picture of the book cover is rendered in picture field 510 along with the title and author. In this page, the user has indicated in field 530 that the condition of the book is “Good.” The user has also added text to free text field 540, i.e., “This book has some highlighting.” Selection of button 544 adds this book to the user's have list with the input information.

FIG. 5C is a view if a page that is rendered after selection of button 544 in FIGS. 5A and 5B. Like FIGS. 5A and 5B, picture field 510 is displayed identifying the added item. A message 550 is also presented that confirms to the user that the item was added to the user's have list. And a message 560 is presented that indicates whether there are tradable items available from other users that this user could get in exchange for the item just added, i.e., C for Dummies by Dan Gookin. In this case, field 560 indicates there are no items available, which means no other user has C for Dummies by Dan Gookin on its want list at that time. This situation could change when another user adds this item to their want list.

Selection of the “Newly Added to Have List” link from the browser content topic 412 of sidebar area 410 causes the page in FIG. 6 to be presented. In main area 430, a set of recently added have list items in each category is shown. A “recently added books” area 610 identifies several recently added books. A “recently added music” area 620 identifies several recently added music CDs. A “recently added dvds” area 630 identifies several recently added movie DVDs. And a “recently added video games” area 640 identifies several recently added video games. In the book category (i.e., under “recently added books”) the book C for Dummies by Dan Gookin shows up as a recently added book, since user John Doe just added it to his have list. This page is available to other users of the automated trading system 70, so could immediately raise interest in these items that leads to a trade.

Each category area includes a selectable link that enables the user to transition to a page that shows all recently added items in the category. As an example, under “recently added books” area 610, a selectable link “view all recently added books” 612 is provided. Selection of link 612 causes all recently added books to be represented in main area 430. For each item there is also a selectable “want it” link 614 that enables the user to add the item to his want list and immediately facilitate a possible trade.

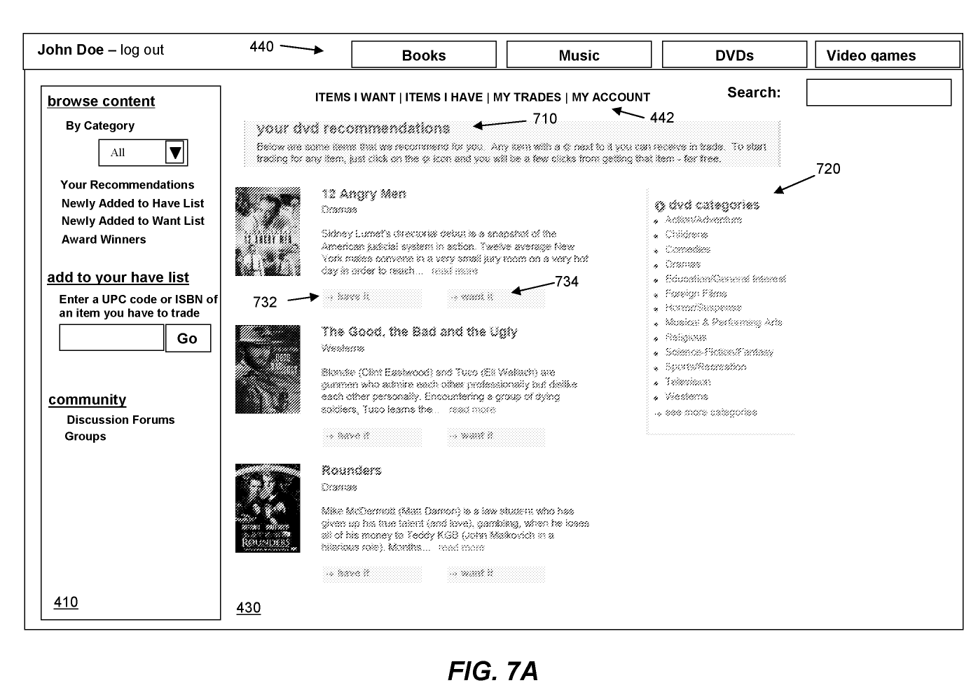

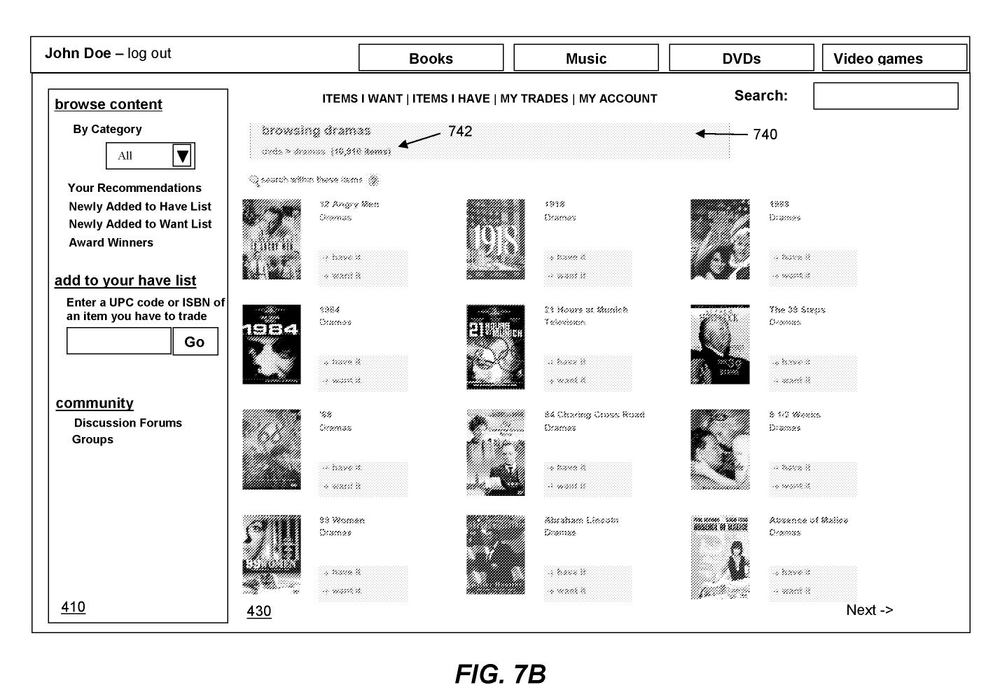

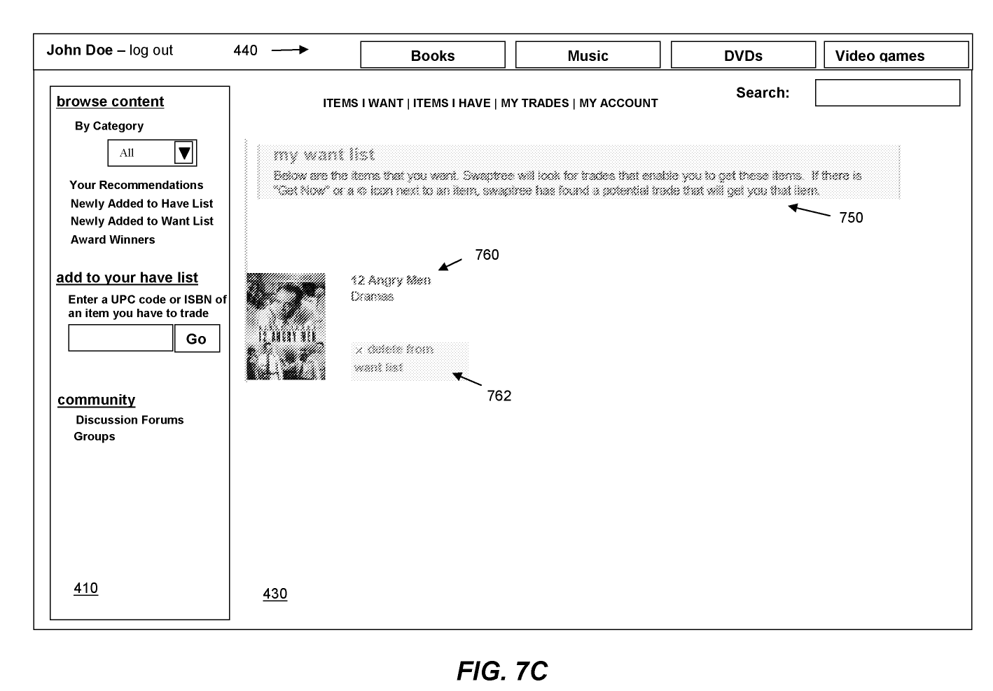

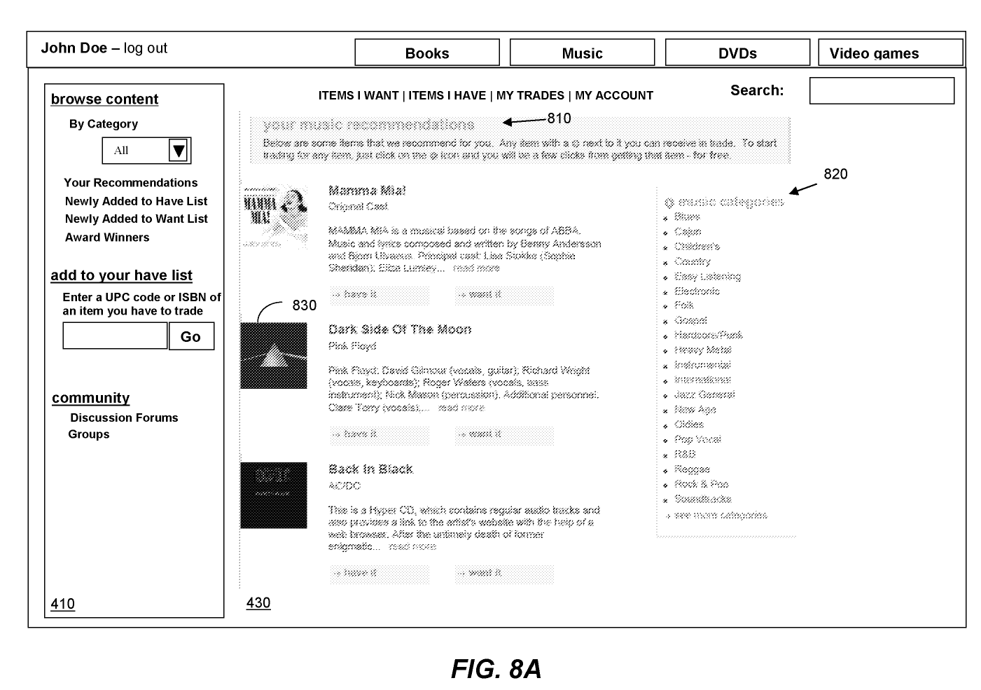

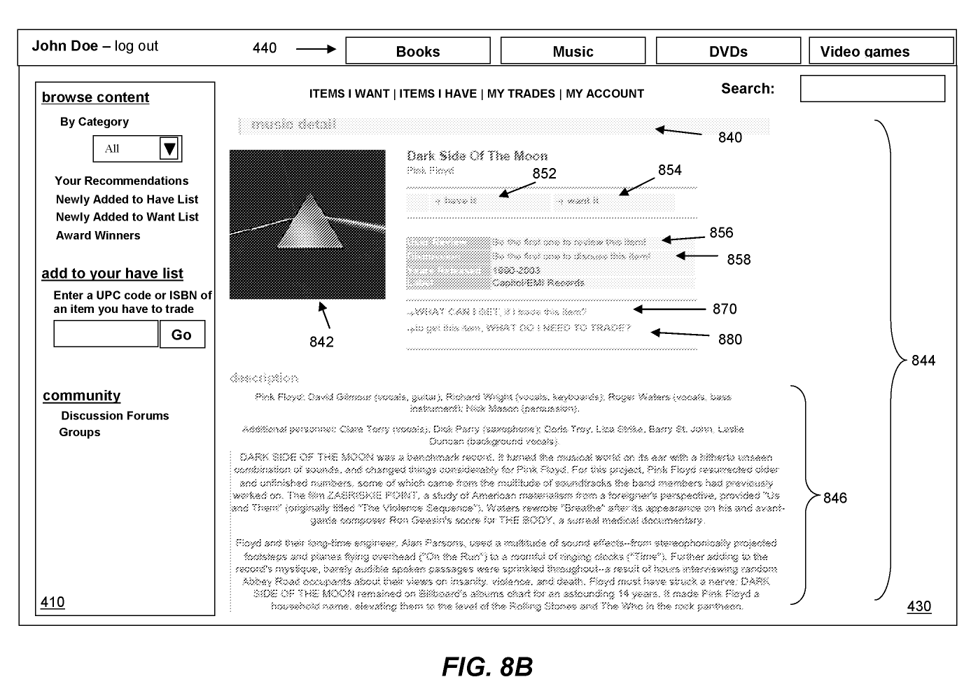

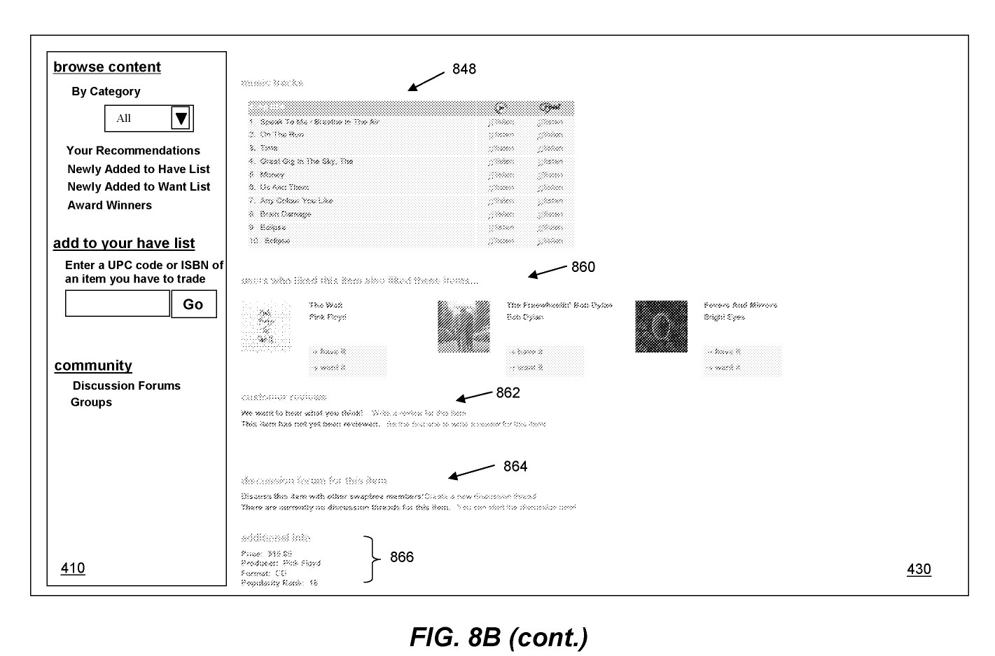

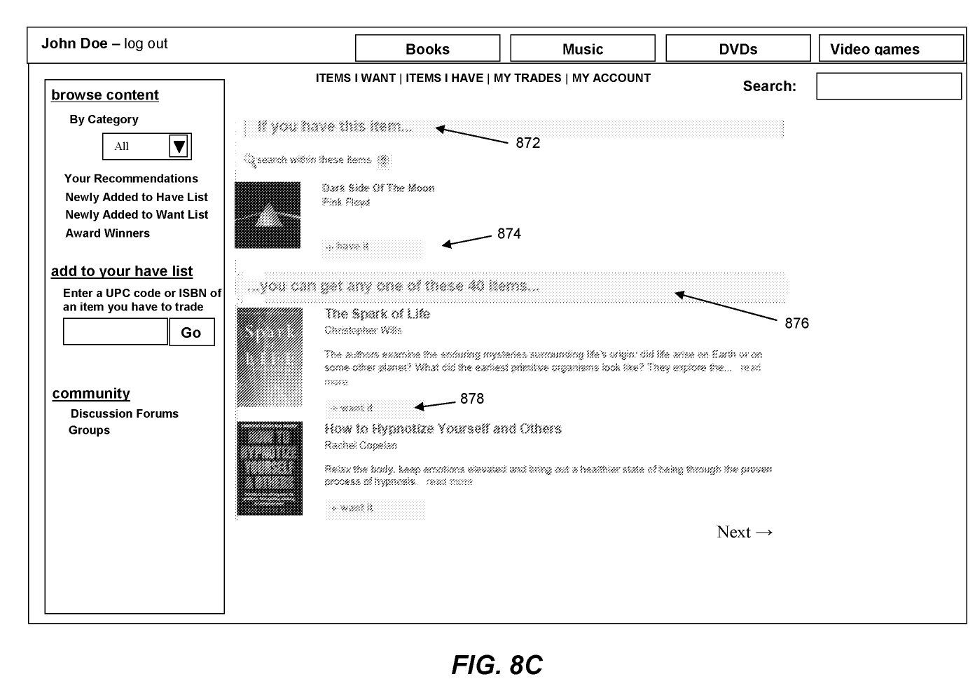

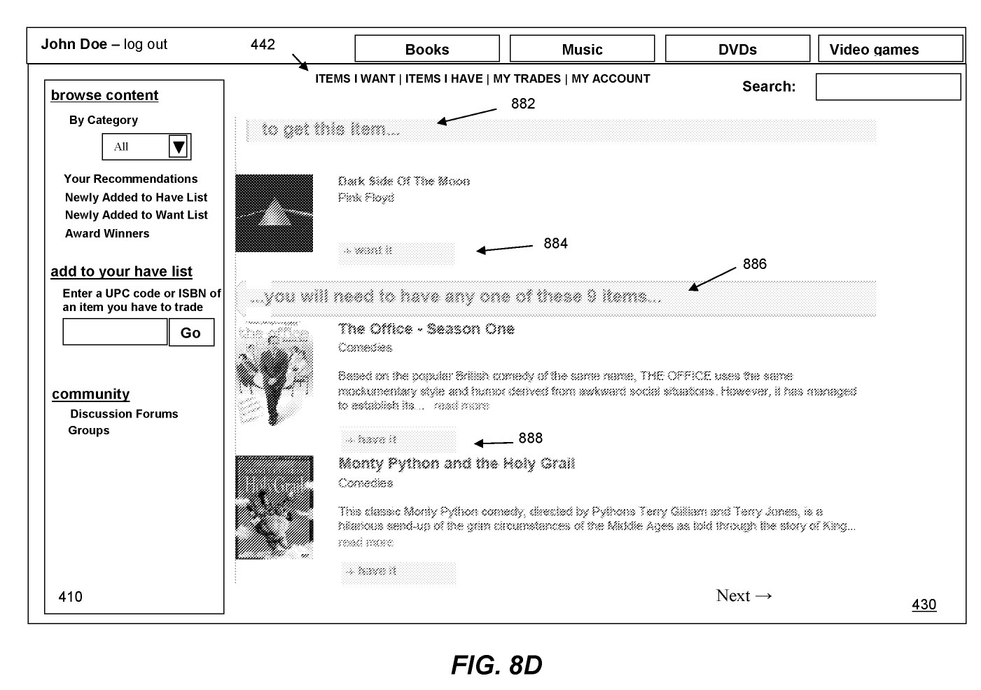

Items can also be added to a user's want list in a variety of other manners. FIGS. 7A through 7C demonstrate how an item can be added to a want list by browsing a category of tradable items, such as those in FIG. 6. Selection of the tab DVDs from tabs 440 or selection of DVDs from pull-down menu 422 causes a page to be presented of DVD recommendations in main area 430, as indicated by banner 710. As noted in banner 710, an indication (e.g., a + symbol) can be presented next to each DVD the user could receive in a trade, based on the user's present have list. A menu of selectable links 720 can also be presented that lists defined movie or DVD categories. Selection of one of the categories, e.g., Dramas, causes the content of main area 430 to present only drama DVDs, as shown in FIG. 7B. The drama DVDs are presented under the banner “browsing dramas” 740. This banner also includes a field 742 that shows the user the number of drama DVDs available, here “10,910 items.” Selection of the icon (or picture) of an item causes an item detail to be presented that gives information about the selected item, as discussed in detail with respect to FIGS. 8A-D.

Returning to FIG. 7A, two selectable options are provided for each tradable item: “have it” 732 and “want it” 734. Selecting one of these options performs the selected action. For example, if the user selects the “have it” option 732 for the movie 12 Angry Men, then main area 430 transitions to a page that enables the user to add the item to the user's have list. Similarly, if the user selects the “want it” option 734 for the movie 12 Angry Men, then main area 430 transitions to a page that enables the user to add the item to the user's want list. These options are available in several pages, e.g., the page shown in FIG. 7B.

For instance, if the user added this movie to his want list in this manner, then when the user makes the selection “Items I Want” from selectable options 442, a representation of the movie will be present. This is shown in FIG. 7C, where the movie 12 Angry Men 760 has been added to the user's want list, under the banner “my want list” 750. Included with the representation of 12 Angry Men 760 is a delete option 762 that allows the item to be easily removed from the user's want list.

FIGS. 8A-D show pages that relate to general browsing functions. If in FIG. 7C the tab “Music” was selected from tabs 440, the page of FIG. 8A can be presented. In FIG. 8, the main area 430 includes recommendations of music CDs, under the banner “your music recommendations” 810. As with the movie/DVD browsing page of FIG. 7A, a menu of selectable links 820 can also be presented that lists defined music categories. Selection of a category from menu 820 causes only music of the selected category to be presented in main area 430.

Selecting the icon for the Dark Side Of The Moon CD 830 in FIG. 8A cause an item detail page that includes information about the selected CD in main area 430—as shown in FIG. 8B. Under the banner “music detail” in FIG. 8B the CD cover 842 is represented along with information 844 related to the CD. The related information 844 includes the CD title, artist, year released, label, and a description 846 of the CD. Also included are the selectable buttons “have it” 852 and “want it” 854, selection of which enables the item to be added to the corresponding have list or want list of the user. A selectable link 856 can be provide to enable a user to provide a review, as can a selectable link 858 for discussion of the item.

The related information 844 can also include a list of the songs on the CD 848, which can include selectable links to play or sample those songs. A section entitled “users who liked this item also liked these items . . . ” 860 can also be included. As suggested, this section identifies items that can also be of interest to a user interested in the item for which the detail is being provided, i.e., the Dark Side Of The Moon CD. A “customer reviews” section 862 can be provided that enables a user to read and add reviews for the item. Similarly, a “discussion forum for this item” section 864 can be provided that enables a user to discuss the item with other users.

And an “additional info” section 866 can be provided to present other information relative to the item. In this embodiment, the additional information is price, producer, format, and popularity rank. The price is purely informational, since in the preferred embodiment trades are made without regard to price or value. The popularity rank is a measure of popularity of an item. It can be determined as a weighted average combination of the number of users that have an item on their have list and number of users that have an item on their want list, as an example.

The item detail in FIG. 8B also includes a selectable link 870 called “WHAT CAN I GET, if I trade this item?” Selecting link 870 causes the page of FIG. 8C to be presented. Under the banner “If you have this item . . . ” 872 the item is represented, i.e., Dark Side Of The Moon CD. A selectable “have it” link 874 can be included to enable the user to quickly add the item to its have list. Under the banner “ . . . you can get any one of these 40 items . . . ” 876 is provided a list of 40 items that could be obtained in a trade to get the item Dark Side Of The Moon CD. That is, the items in this section are on the have lists of one or more users that want the Dark Side Of The Moon CD, i.e., have it on their want lists. So, if the user wants to initiate a trade for the book Spark of Life, the user could add Dark Side Of The Moon CD to its have list by selecting “have it” link 874 and selecting “want it” link 878 associated with the Spark of Life. Note that this section is not limited to music items, since users are not limited to trading within the same category.

The item detail in FIG. 8B also includes a selectable link 880 called “TO GET THIS ITEM, what do I need to trade?” Selecting link 880 causes the page of FIG. 8D to be presented. Under the banner “to get this item . . . ” 882 the item is represented, i.e., Dark Side Of The Moon CD. A selectable “want it” link 884 can be included to enable the user to quickly add the item to its want list. Under the banner “ . . . you will need to have any one of these 9 items . . . ” 876 there is provided a list of 9 items that could be used in a trade to get the item Dark Side Of The Moon CD. That is, the items in this section are on the want lists of one or more users that have the Dark Side Of The Moon CD on it or their have lists. So, if the user has DVD The Office—Season One, he could initiate a trade for Dark Side Of The Moon CD by selecting “want it” link 884 to add it to his want list and selecting “have it” link 888 to add The Office—Season One to his have list. Note that this section is not limited to music items, since users are not limited to trading within the same category.

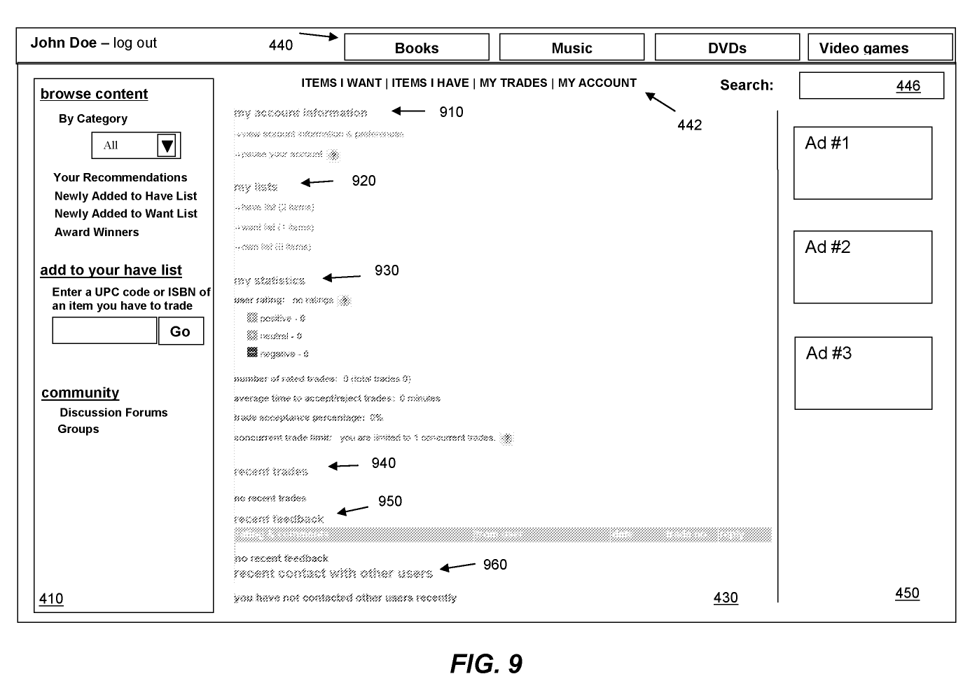

As indicated preciously, and as shown in FIG. 8D, across the top of main area 430 is a set selectable links 442 that allow the user to migrate to certain ones of its pages. If the user selects the “My Account” link the page of FIG. 9 is presented, which causes the user's account information to be displayed in main area 430. Under the banner “My account information” 910, there are two selectable links. The “view account information and preferences” link enables a user to review and change its account information, e.g., username, address, and e-mail address, and preferences, e.g., e-mail formats, whether or not e-mail notices about new releases are desired, and frequency of e-mails identifying new items the user can get based on changes to have lists and want lists of other users—as examples.

Under the banner “my lists” 920 are three selectable links: “have list (2 items);” “want list (1 items); and “own list (0 items).” Thus, a parenthetical note of the number of items currently in each category can be provided. Selecting the “have list” link enables a user to review the items on its, have list. Selecting the “want list” link enables the user to review the items on his want list. And selecting the “own link” enables a user to review the items it has entered into the system has having, but which have not been made available for trade.

Under the banner “my statistics” 930 three rating levels are shown, with a numerical representation of how many other users have given the user John Doe a rating at each level, i.e., positive, neutral, and negative. An overall user rating can also be provided, which can be based on an average of ratings across the three levels. In the automated trading system, the ratings of other users are preferably made after trade completion. Other trade related information can also be provided, as shown in FIG. 9. In this embodiment, the “number of rated trades,” “average time to accept/reject trades,” “trade acceptance percentage,” and “concurrent trade limit” are all included.

A summary of recent trades can be provided under the banner “recent trades” 940. Under the banner “recent feedback” 950 a review of recent feedback from other users can be provided, including an identification of the date of the feedback and trade number to which it pertains, i.e., each trade can be given a unique trade number. Under the banner “recent contact with other users” 960 a review of the user's recent communications with other users can be provided.

Additionally, advertisements can be presented in the secondary area 450, if included, such as Ad #1, Ad #2, and Ad #2. Additionally, or alternatively, ads can be provided in any other manner disclosed herein. Although not shown in FIGS. 4-8D, ads could be provided in any of those screens. Ads could additionally, or alternatively, be provided on a user device and outside areas 410, 430, and 450.

In the context of automated trading system 70, the user interface module 72 could comprise a set of functional modules configured to provide a set of user interface mechanisms and information as discussed herein. As an example, user interface module 72 could include an input module configured to provide mechanisms for receiving user inputs and an output module to generate various outputs, including outputs responsive to mechanism to user inputs received via the input mechanisms.

It will be apparent to those skilled in the art that various modifications and variations can be made to the method and system of the present disclosure. Other embodiments of the method and system will be apparent to those skilled in the art from consideration of the specification and practice of the method and system disclosed herein. For example, automated trading system 70 can be combined with other systems or methods for buying and selling items that are presently known in the art. It is intended that the specification and examples be considered as exemplary only, with a true scope of the disclosure being indicated by the following claims and their equivalents.

What is claimed is:

1. A method of generating a set of user interface mechanisms for presentation via a user device to facilitate automated trading of items among two or more users, the method comprising:
generating input mechanisms configured to receive an item identification for a first tradable item from a first user associated with an automated trading system; and
in response to receiving the item identification, generating an output indicating at least one other tradable item associated with a trade involving the first tradable item, wherein the at least one other tradable item is associated with at least one other user associated with the automated trading system.

2. The method of claim 1, wherein the trade is an N-way trade that includes more than two tradable items and more than two users associated with the more than two tradable items.

3. The method of claim 1, wherein the first tradable item is a have item of the first user and the input mechanisms include mechanisms configured to enable the first user to initiate a trade for a second item from the at least one other tradable item.

4. The method of claim 3, wherein the input mechanisms include mechanisms configured to enable the first user to add the second item to a want list of the first user.

5. The method of claim 3, further including, upon initiation of a trade for the second item, generating one or more trade acceptance outputs to users involved in the trade.

6. The method of claim 5, further including, upon receipt of an indication of acceptance by each user involved in the trade, outputting a trade verification to each user involved in the trade including shipping instructions.

7. The method of claim 6, further including providing an interactive mechanism configured to allow each user involved in the trade to rate at least one other of the users involved in the trade.

8. The method of claim 5, wherein the one or more trade acceptance outputs includes a rating associated with one or more other users involved in the trade

9. The method of claim 3, wherein generating the input mechanisms to enable the first user to initiate the trade includes generating for output a trade leg including data representative of the have item and the second item.

10. The method of claim 3, wherein generating the input mechanisms to enable the first user to initiate the trade includes generating for output a trade table including data representative of the have item and the second item including a two-dimensional matrix containing data representative of the have item and the second item.

11. The method of claim 1, wherein the first tradable item is a have item associated with the first user, the method further including providing an interactive mechanism configured to enable the first user to associate a condition with the have item.

12. The method of claim 1, wherein the first tradable item is a have item associated with the first user, the method further including providing an interactive mechanism configured to enable the first user to enter comments related to the have item.

13. The method of claim 1, wherein the item identification includes an ISBN or a UPC.

14. The method of claim 1, wherein input of the item identification causes an icon of the first tradable item to be automatically output.

15. The method of claim 1, wherein the input mechanisms enable the first user to input the item identification from one or more of a bar code reader, a text interface, a voice interface, touch screen, keypad, and interactive graphical mechanism.

16. The method of claim 1, further including determining in real-time the at least one other tradable item that could be used in a trade involving the first tradable item.

17. The method of claim 1, wherein the user interface includes at least one of a voice interface, an email interface, and a browser interface.

18. The method of claim 1, further comprising providing an interactive mechanism configured to enable the first user to obtain a condition of a selected item from the other items.

19. The method of claim 1, further comprising providing an interactive mechanism configured to enable the first user to obtain a rating of a user associated with a second tradable item selected from the at least one other tradable item.

20. The method of claim 1, wherein generating the output indicating the at least one other tradable item includes generating user selectable icons representing the at least one other tradable item.

21. The method of claim 20, further including, in response to selection of an icon representing a second tradable item from the at least one other tradable item, outputting item detail information related to the selected second tradable item.

22. The method of claim 21, wherein the item detail information includes a selectable link that, when selected, generates an output indicating a set of tradable items, wherein any one tradable item from the set of tradable items could be used by the first user to obtain the selected second tradable item.

23. The method of claim 21, wherein the item detail information includes a selectable link that, when selected, generates an output indicating a set of tradable items, wherein any one of the tradable items from the set of tradable items can be obtained by the first user in exchange for the selected tradable item.

24. The method of claim 1, further including providing an interactive mechanism configured to output a trade history of the first user.

25. The method of claim 1, further including providing an interactive mechanism configured to output trade-based performance statistics determined from a trade history of the second user from the at least one other user.

26. The method of claim 1, further including providing an interactive mechanism configured to output recommendations of tradable items for the first user.

27. The method of claim 26, wherein the recommendations are determined based on a tradable item in at least one of a have list and a want list of the first user.

28. The method of claim 26, wherein the recommendations are categorized by content type from a set of content types, wherein the set of content types comprises one or more of books, music, movies, and video games.

29. The method of claim 1, the method further including providing an interactive mechanism configured to output newly added have list items on have lists of a plurality of users.

30. The method of claim 1, further including providing an interactive mechanism configured to output newly added want list items on want lists of a plurality of users.

31. A computer program product configured for storage on at least one storage media and for execution by at least one processor to execute a method of generating a set of user interface mechanisms for presentation via a user device to facilitate automated trading of items among two or more users, the method comprising:
generating input mechanisms configured to receive an item identification for a first tradable item from a first user associated with an automated trading system; and
in response to receiving the item identification, generating an output indicating at least one other tradable item associated with a trade involving the first tradable item, wherein the at least one other tradable item is associated with at least one other user associated with the automated trading system.

32. The computer program product of claim 31, wherein the first tradable item is a have item of the first user and generating the output includes determining the at least one other tradable item as have list items of the at least one other user that include the have item on their respective want lists.

33. The computer program product of claim 31, wherein the first tradable item is a want item of the first user and generating the output includes determining the at least one other tradable item as want list items of other users that include the want item on their respective have lists.

34. The computer program product of claim 31, the method further including providing an interactive mechanism configured to output newly added have list items on have lists of a plurality of users.

35. The computer program product of claim 31, the method further including providing an interactive mechanism configured to output newly added want list items on want lists of a plurality of users.

36. The computer program product of claim 31, wherein the trade is an N-way trade that includes more than two tradable items and more than two users associated with the more than two tradable items.

37. The computer program product of claim 31, wherein the input mechanisms include mechanisms configured to enable the user to initiate a trade involving the first tradable item and a second item from the at least one other tradable item.

38. The computer program product of claim 31, the method further including providing an interactive mechanism configured to output recommendations of tradable items for the first user.

39. The computer program product of claim 38, wherein the recommendations are categorized by content type from a set of content types, wherein the set of content types comprises one or more of books, music, movies, and video games.

40. A user interface system configured to generate a set of user interface mechanisms for presentation via a user device to facilitate automated trading of items among two or more users, the system comprising:
an input module configured to generate input mechanisms configured to receive an item identification for a first tradable item from a first user associated with an automated trading system; and
an output module configured, in response to input of the item identification, to generate an output indicating at least one other tradable item associated with a trade involving the first tradable item, wherein the at least one other tradable item is associated with at least one other user associated with the automated trading system.

41. The system of claim 40, wherein the first tradable item is a have item of the first user and the output module is configured to generate the output of the at least one other tradable item as have list items of the at least one other user that include the have item on their respective want lists.

42. The system of claim 40, wherein the first tradable item is a want item of the first user and the output module is configured to generate the output of the at least one other tradable item as want list items of other users that include the want item on their respective have lists.

43. The system of claim 40, wherein the output module is configured to provide an interactive mechanism configured to output newly added have list items on the have lists of a plurality of users.

44. The system of claim 40, wherein the output module is configured to provide an interactive mechanism configured to output newly added want list items on the want lists of a plurality of users.

45. The system of claim 40, wherein the trade is an N-way trade that includes more than two tradable items and more than two users associated with the more than two tradable items.

46. The system of claim 40, wherein the input module is configured to provide an interactive mechanism configured to enable the first user to initiate a trade involving the first item and a second item from the at least one of the other tradable item.

47. The system of claim 40, wherein the output module is configured to provide an interactive mechanism configured to output recommendations of tradable items for the first user.

48. The system of claim 47, wherein the recommendations are categorized by content type from a set of content types, wherein the set of content types comprises one or more of books, music, movies, and video games.
